(19) United States
(12) Patent Application Publication
(10) Pub. No.: US 2019/0207876 A1
(43) Pub. Date: Jul. 4, 2019

(54) SYSTEMS AND METHODS FOR USING NATURAL LANGUAGE INSTRUCTIONS WITH AN AI ASSISTANT ASSOCIATED WITH MACHINE LEARNING CONVERSATIONS

(71) Applicant: Conversica, Inc., Foster City, CA (US)

(72) Inventors: George Alexis Terry, Woodside, CA (US); Werner Koepf, Seattle, WA (US); James D. Harriger, Duvall, WA (US); William Dominic Webb-Purkis, San Francisco, CA (US); Siddhartha Reddy Jonnalagadda, Bothell, WA (US); Gabriel Vincent Martini, Bellingham, WA (US)

(21) Appl. No.: 16/228,717

(22) Filed: Dec. 20, 2018

Related U.S. Application Data
(63) Continuation-in-part of application No. 16/019,382, filed on Jun. 26, 2018.
Application No. 16/019,382 is a continuation-in-part of application No. 14/604,610, filed on Jan. 23, 2015, now Pat. No. 10,026,037.
Application No. 14/604,610 is a continuation-in-part of application No. 14/604,602, filed on Jan. 23, 2015.
Application No. 14/604,602 is a continuation-in-part of application No. 14/604,594, filed on Jan. 23, 2015.
(60) Provisional application No. 62/612,020, filed on Dec. 29, 2017.

(51) Int. Cl. H04L 12/58; G06Q 10/10; G06K 9/62

(52) U.S. Cl. CPC H04L 51/02; G06K 9/6267; G06Q 10/1093

(57) ABSTRACT

Systems and methods for more effective AI operations, improvements to the experience of a conversation target, and increased productivity through AI assistance are provided. In some embodiments, the systems use machine learning models to classify a number of message responses with a confidence. If these classifications are below a threshold the messages are sent to a user for analysis, after prioritization, along with guidance data. Feedback from the user modified the models. In another embodiment, a system and method for an AI assistant is also provided which receives messages and determines instructions using keywords and/or classifications. The AI assistant then executes upon these instructions. In another embodiment, a conversation editor interface is provided. The conversation editor includes one or more displays that illustrate an overview flow diagram for the conversation, specific node analysis, libraries of conversations and potentially metrics that can help inform conversation flow. Lastly, task gamification may additionally be employed in order to increase the messaging system's performance.

### CROSS REFERENCE TO RELATED APPLICATIONS

This continuation-in-part application is a non-provisional and claims the benefit of U.S. provisional application entitled “Systems and Methods for Human to AI Cooperation in Association with Machine Learning Conversations,” U.S. provisional application No. 62/612,020, Attorney Docket No. CVSC-17D-P, filed in the USPTO on Dec. 29, 2017, currently pending.

This continuation-in-part application also claims the benefit of U.S. application entitled “Systems and Methods for Natural Language Processing and Classification,” U.S. application Ser. No. 16/019,382, Attorney Docket No. CVSC-17A1-US, filed in the USPTO on Jun. 26, 2018, pending, which is a continuation-in-part application which claims the benefit of U.S. application entitled “Systems and Methods for Configuring Knowledge Sets and AI Algorithms for Automated Message Exchanges,” U.S. application Ser. No. 14/604,610, Attorney Docket No. CVSC-1403, filed in the USPTO on Jan. 23, 2015, now U.S. Pat. No. 10,026,037 issued Jul. 17, 2018. Additionally, U.S. application Ser. No. 16/019,382 claims the benefit of U.S. application entitled “Systems and Methods for Processing Message Exchanges Using Artificial Intelligence,” U.S. application Ser. No. 14/604,602, Attorney Docket No. CVSC-1402, filed in the USPTO on Jan. 23, 2015, pending, and U.S. application entitled “Systems and Methods for Management of Automated Dynamic Messaging,” U.S. application Ser. No. 14/604,594, Attorney Docket No. CVSC-1401, filed in the USPTO on Jan. 23, 2015, pending.

This application is also related to co-pending and concurrently filed in the USPTO on Dec. 20, 2018, U.S. application Ser. No. 16/228,712, entitled “Systems and Methods for Training and Auditing AI Systems in Machine Learning Conversations”, Attorney Docket No. CVSC-17D1-US, U.S. application Ser. No. ______, entitled “Systems and Methods for Configuring Message Exchanges in Machine Learning Conversations”, Attorney Docket No. CVSC-17D3-US and U.S. application Ser. No. ______, entitled “Systems and Methods for Improving User Engagement in Machine Learning Conversation Management using Gamification”, Attorney Docket No. CVSC-17D4-US.

All of the above-referenced applications/patents are incorporated herein in their entirety by this reference.

### BACKGROUND

The present invention relates to systems and methods for enabling and enhancing the cooperation between human operators and Artificial Intelligence (AI) systems that are employed in the context of machine learned conversation systems. These conversational AIs include, but are not limited to, message response generation, AI assistant performance, and other language processing, primarily in the context of the generation and management of a dynamic conversations. Such systems and methods provide a wide range of business people more efficient tools for outreach, knowledge delivery, automated task completion, and also improve computer functioning as it relates to processing documents for meaning. In turn, such system and methods enable more productive business conversations and other activities with a majority of tasks performed previously by human workers delegated to artificial intelligence assistants.

Artificial Intelligence (AI) is becoming ubiquitous across many technology platforms. AI enables enhanced productivity and enhanced functionality through “smarter” tools. Examples of AI tools include stock managers, chatbots, and voice activated search-based assistants such as Siri and Alexa. With the proliferation of these AI systems, however, come challenges for user engagement, quality assurance and oversight, and feedback by human operators to the AI systems remain.

The ability for human operators to cooperate and interact effectively with AI systems is ultimately required for effective deployment and operation of these systems. For example, for chatbots, or any AI system that converses with a human, the input message can vary almost indefinitely. Even for a particular question or point, the ways this may be stated are many. For systems that need to interpret human dialog, and respond accordingly, simple rule based systems are typically inadequate. More complicated machine learning systems that generate complex models may allow for more accurate AI operation. These models however, even in the best circumstances, are periodically going to fail and require human intervention. By enabling a seamless transfer between the AI system and a human operator, the conversation cadence and experience for the conversation target is not compromised. Likewise, the human intervention can allow for training opportunities for the AI models.

Additionally, the AI systems contemplated here invariably require some basic level inputs from domain experts in order to function optimally. Often, based upon AI system deployment, there isn't a way to ensure that users provide this critical information to the system. Failure to do so may heavily compromise the effectiveness of the AI.

Lastly, while AI systems can be dependent upon human interaction for effective performance, it is also possible that AI systems may interface with human users to enable completion of particular tasks in a discrete setting of conversational AI management.

It is therefore apparent that an urgent need exists for advancements in the cooperation between AI systems and human operators that enables more effective AI operations, improvements to the experience of a conversation target, and increased productivity through AI assistance. Such systems and methods allow for improved conversations and for added functionalities.

### SUMMARY

To achieve the foregoing and in accordance with the present invention, systems and methods for AI to human cooperation are provided. Such systems and methods allow for more effective AI operations, improvements to the experience of a conversation target, and increased productivity through AI assistance.

In some embodiments, a computer implemented method for human intervention in a conversation between a target and an Artificial Intelligence (AI) messaging system is provided. Such a system and method begins by using machine learning models to classify a number of message responses. Along with the classification the confidence for the classification is calculated. Some of these classifications will have high confidence scores and may be acted upon by the system automatically, but other message classifications may not be as sure. If these classifications are below a threshold the messages are sent to a user for analysis.

The messages sent to the user must be first prioritized. This is done according to channel of communication, client involved, topic of the message and the presence of keywords that suggest the message is urgent. Once prioritized, the messages may have additional information compiled for presentation to the user along with the message to improve the decision making quality and speed by the user. This additional information may include a histogram of historical responses that were also below the threshold for that classification, and the ultimate outcome after human review. Timing suggestions and possible actions to take may likewise be presented to the user.

After receiving a selection from the user the action may be undertaken, and the machine learning model may be updated using this feedback. The threshold for confidence may be configurable, and commonly may be between 80% to 99%, 90% to 98%, 93% to 97% or 95%.

In another embodiment, a system and method for an AI assistant is also provided. This AI assistant is used in to receive messages from a client which includes instructions for a representative. The message may be analyzed to determine what the instructions are, and then execute necessary actions based upon these instructions. The instructions typically include actions such as sending a target a message to set up a meeting and the like.

The instructions may be identified in the message based upon keyword matching, or more complicated classification techniques. The keywords and/or classifications may be cross referenced against commands to determine which actions are appropriate. The AI assistant can have access to email accounts, calendars or other databases in order to allow for action execution.

In another embodiment, a conversation editor interface is provided. The conversation editor includes one or more displays that illustrate an overview flow diagram for the conversation, specific node analysis, libraries of conversations and potentially metrics that can help inform conversation flow. An extension to the conversation editor interface is a semi-automated conversation messaging system that augments the human-curated paths of conversation with machine suggested conversations based on the proactive and reactive capabilities of the conversational AI assistant.

The metrics, when present, may include collated industry, segment and manufacturer metrics. The conversation library includes listings of the conversations belonging to the user, and allows for editing of the conversations. Once a conversation is selected, the system may generate an overview flow diagram for the conversation. Any element of the conversation flow may be selected and individually viewed or edited. If a particular node is selected, the system displays the question associated with the node, determines upstream nodes, determines actions occurring at the node, and provides example intents that result in the given action taking place.

The volume of conversations that have occurred for each of these action-intent pairings is also presented to the user along with other node specific quality measures. These measures may include the percentage of messages for the primary node that are sent to a training desk, the percentage of messages for the primary node that are not sent to the training desk but are corrected at an audit desk, and the percentage of messages for the primary node that are sent to the training desk and are corrected at the audit desk. The user may update the intent-action pairings in this interface, and when a change has been made the conversation overview may be updated accordingly.

For the purpose of this disclosure, “training desk” means a human operator who reviews and provides feedback regarding classifications and/or actions to be taken in regard to a particular message. Likewise, “audit desk” may be a human expert or a panel of human operators that provides review and accuracy determinations after the fact on classifications and/or actions made in regard to a message. Messages are routed to the training desk when confidence thresholds for the machine learned models are not met. In contrast, messages are routed for review of the audit desk either wholesale, or in a randomized or pseudorandomized fashion. The audit desk may receive messages and classifications or actions taken by the machine learned model, as well as messages and the actions taken by human operators at the training desk, in order to generate accuracy metrics for all stages of the conversation response system.

In some embodiments, tasks gamification may additionally be employed in order to increase the messaging system's performance. The messaging system is dependent upon user inputs to operate optimally. These tasks are not guaranteed to be completed however, and by employing gamification the chance of the tasks being completed is increased. For gamification the tasks are initially prioritized based upon if they are necessary for system operation, or based upon how significantly a given task impacts an objective of a conversation. Additional innovations in gamification will include creation of subtasks such as judging the correctness of intents, entities learnt by AI and dynamic conversations generated by AI. User interfaces for gamification will include not converting training desk and audit desk tasks to multi-sensory games involving video, audio and haptic communication between AI and humans. Example applications could include mobile and cloud apps and gaming consoles.

After prioritization, awards are modified based upon the prioritization. These awards may be as simple as digital badges, or the like, or may include more tangible rewards. More tangible awards may include cash bonuses, non-cash gifts/trophies, or impact upon the user's employment performance review. The awards may also be displayed to the user in order to impact behaviors. Additional innovations in awards will involve the amplification of the strengths and skills to the human training desk and audit desk user's avatar in the gaming universe that is shared with other users (gamers). Multi-sensory human-AI interaction will be used to reduce the cognitive workload of users to the point of making their tasks addictive.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is an example logical diagram of a system for generation and implementation of messaging conversations, in accordance with some embodiment;

FIG. 2 is an example logical diagram of a dynamic messaging server, in accordance with some embodiment;

FIG. 3 is an example logical diagram of a user interface within the dynamic messaging server, in accordance with some embodiment;

FIG. 4 is an example logical diagram of a message generator within the dynamic messaging server, in accordance with some embodiment;

FIG. 5A is an example logical diagram of a message response system within the dynamic messaging server, in accordance with some embodiment;

FIG. 5B is an example logical diagram of a training desk within the message response system, in accordance with some embodiment;

FIG. 5C is an example logical diagram of a natural language account manager and AI assistant in the message response system, in accordance with some embodiment;

FIG. 5D is an example logical diagram of a conversation editor system within the message response system, in accordance with some embodiment;

FIG. 6 is an example flow diagram for a dynamic message conversation, in accordance with some embodiment;

FIG. 7 is an example flow diagram for the process of on-boarding a business actor, in accordance with some embodiment;

FIG. 8 is an example flow diagram for the process of building a business activity such as conversation, in accordance with some embodiment;

FIG. 9 is an example flow diagram for the process of generating message templates, in accordance with some embodiment;

FIG. 10 is an example flow diagram for the process of implementing the conversation, in accordance with some embodiment;

FIG. 11 is an example flow diagram for the process of preparing and sending the outgoing message, in accordance with some embodiment;

FIG. 12 is an example flow diagram for the process of processing received responses, in accordance with some embodiment;

FIG. 13 is an example flow diagram for the process of document cleaning, in accordance with some embodiment;

FIG. 14 is an example flow diagram for the utilization of the training desk system, in accordance with some embodiment;

FIG. 15 is an example flow diagram for the process of the natural language account management via an AI assistant, in accordance with some embodiment;

FIG. 16 is an example flow diagram for the process of generating a conversation editor interface, in accordance with some embodiment;

FIG. 17A is an example flow diagram for the process of task gamification, in accordance with some embodiment;

FIG. 17B is an example illustration of a gamification dashboard, in accordance with some embodiment;

FIG. 18 is an example flow diagram for the process of metric generation and reporting, in accordance with some embodiment;

FIG. 19 is an example illustration of a configurable AI assistant within a conversation system, in accordance with some embodiment;

FIG. 20 is an example illustration of a conversation editor dashboard, in accordance with some embodiment;

FIG. 21 is an example illustration of a channel specific message template, in accordance with some embodiment;

FIG. 22 is an example illustration of a graphical conversation overview within a conversation editor tool, in accordance with some embodiment;

FIG. 23 is an example illustration is a conversation editor overview interface, in accordance with some embodiment; and

FIGS. 24A and 24B are example illustrations of a computer system capable of embodying the current invention.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

The present invention relates to cooperation between business actors such as human operators and AI systems. While such systems and methods may be utilized with any AI system, such cooperation systems particularly excel in AI systems relating to the generation of automated messaging for business conversations such as marketing and other sales functions. While the following disclosure is applicable for other combinations, we will focus upon mechanisms of cooperation between human operators and AI marketing systems as an example, to demonstrate the context within which the cooperation system excels.

The following description of some embodiments will be provided in relation to numerous subsections. The use of subsections, with headings, is intended to provide greater clarity and structure to the present invention. In no way are the subsections intended to limit or constrain the disclosure contained therein. Thus, disclosures in any one section are intended to apply to all other sections, as is applicable.

The following systems and methods are for improvements in AI cooperation with human operators, within conversation systems, and for employment domain specific assistant systems. The goal of the message conversations is to enable a logical dialog exchange with a recipient, where the recipient is not necessarily aware that they are communicating with an automated machine as opposed to a human user. This may be most efficiently performed via a written dialog, such as email, text messaging, chat, etc. However, it is entirely possible that given advancement in audio and video processing, it may be entirely possible to have the dialog include audio or video components as well.

In order to effectuate such an exchange, an AI system is employed within an AI platform within the messaging system to process the responses and generate conclusions regarding the exchange. These conclusions include calculating the context of a document, intents, entities, sentiment and confidence for the conclusions. Human operators cooperate with the AI to ensure as seamless an experience as possible, even when the AI system is not confident or unable to properly decipher a message. Human operator cooperation is also necessary for ongoing training of the AI models, the incorporation of needed data into AI models, and configuring of AI responses.

### I. Dynamic Messaging Systems

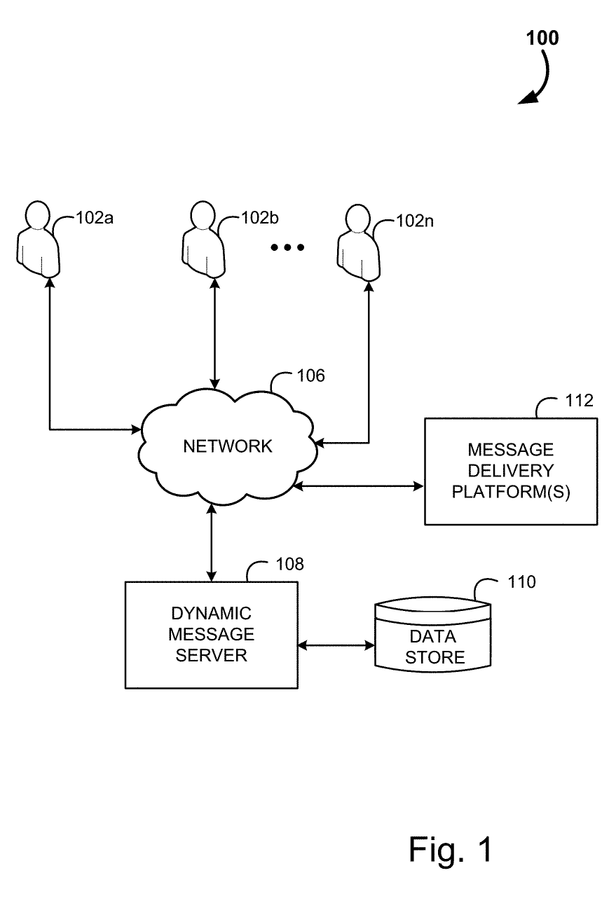

To facilitate the discussion, FIG. 1 is an example logical diagram of a system for generating and implementing messaging conversations, shown generally at 100. In this example block diagram, several users 102a-n are illustrated engaging a dynamic messaging system 108 via a network 106. Note that messaging conversations may be uniquely customized by each user 102a-n in some embodiments. In alternate embodiments, users may be part of collaborative sales departments (or other collaborative group) and may all have common access to the messaging conversations. The users 102a-n may access the network from any number of suitable devices, such as laptop and desktop computers, work stations, mobile devices, media centers, etc.

The network 106 most typically includes the internet, but may also include other networks such as a corporate WAN, cellular network, corporate local area network, or combination thereof, for example. The messaging server 108 may distribute the generated messages to the various message delivery platforms 112 for delivery to the individual recipients. The message delivery platforms 112 may include any suitable messaging platform. Much of the present disclosure will focus on email messaging, and in such embodiments the message delivery platforms 112 may include email servers (Gmail, yahoo, Hotmail, etc.). However, it should be realized that the presently disclosed systems for messaging are not necessarily limited to email messaging. Indeed, any messaging type is possible under some embodiments of the present messaging system. Thus, the message delivery platforms 112 could easily include a social network interface, instant messaging system, text messaging (SMS) platforms, or even audio telecommunications systems.

One or more data sources 110 may be available to the messaging server 108 to provide user specific information, message template data, knowledge sets, intents, and target information. These data sources may be internal sources for the system's utilization, or may include external third-party data sources (such as business information belonging to a customer for whom the conversation is being generated). These information types will be described in greater detail below.

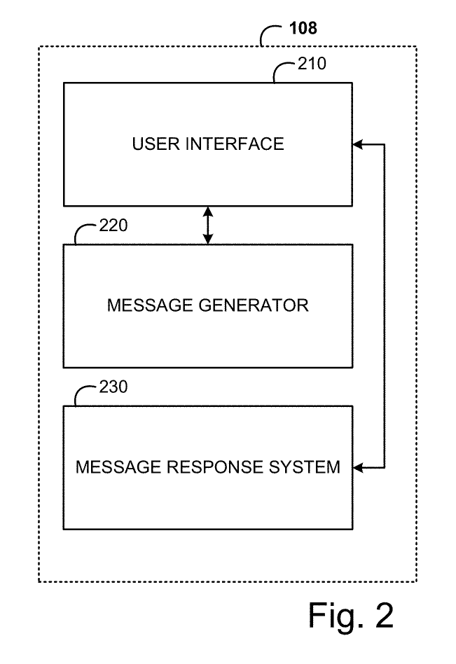

Moving on, FIG. 2 provides a more detailed view of the dynamic messaging server 108, in accordance with some embodiment. The server is comprised of three main logical subsystems: a user interface 210, a message generator 220, and a message response system 230. The user interface 210 may be utilized to access the message generator 220 and the message response system 230 to set up messaging conversations, and manage those conversations throughout their life cycle. At a minimum, the user interface 210 includes APIs to allow a user's device to access these subsystems. Alternatively, the user interface 210 may include web accessible messaging creation and management tools, as will be explored below in some of the accompanying example screenshots.

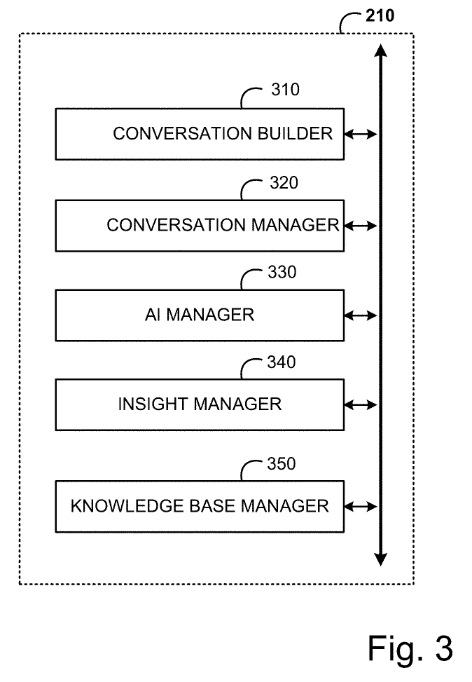

FIG. 3 provides a more detailed illustration of the user interface 210. The user interface 210 includes a series of modules to enable the previously mentioned functions to be carried out in the message generator 220 and the message response system 230. These modules include a conversation builder 310, a conversation manager 320 an AI manager 330, an intent manager 340, and a knowledge base manager 350.

The conversation builder 310 allows the user to define a conversation, and input message templates for each series/exchange within the conversation. A knowledge set and target data may be associated with the conversation to allow the system to automatically effectuate the conversation once built. Target data includes all the information collected on the intended recipients, and the knowledge set includes a database from which the AI can infer context and perform classifications on the responses received from the recipients.

The conversation manager 320 provides activity information, status, and logs of the conversation once it has been implemented. This allows the user 102a to keep track of the conversation's progress, success and allows the user to manually intercede if required. The conversation may likewise be edited or otherwise altered using the conversation manager 320.

The AI manager 330 allows the user to access the training of the artificial intelligence which analyzes responses received from a recipient. One purpose of the given systems and methods is to allow very high throughput of message exchanges with the recipient with relatively minimal user input. To perform this correctly, natural language processing by the AI is required, and the AI (or multiple AI models) must be correctly trained to make the appropriate inferences and classifications of the response message. The user may leverage the AI manager 330 to review documents the AI has processed and has made classifications for.

The intent manager 340 allows the user to manage intents. As previously discussed, intents are a collection of categories used to answer some question about a document. For example, a question for the document could include “is the lead looking to purchase a car in the next month?” Answering this question can have direct and significant importance to a car dealership. Certain categories that the AI system generates may be relevant toward the determination of this question. These categories are the ‘intent’ to the question, and may be edited or newly created via the intent manager 340.

In a similar manner, the knowledge base manager 350 enables the management of knowledge sets by the user. As discussed, a knowledge set is set of tokens with their associated category weights used by an aspect (AI algorithm) during classification. For example, a category may include “continue contact?”, and associated knowledge set tokens could include statements such as “stop”, “do no contact”, “please respond” and the like.

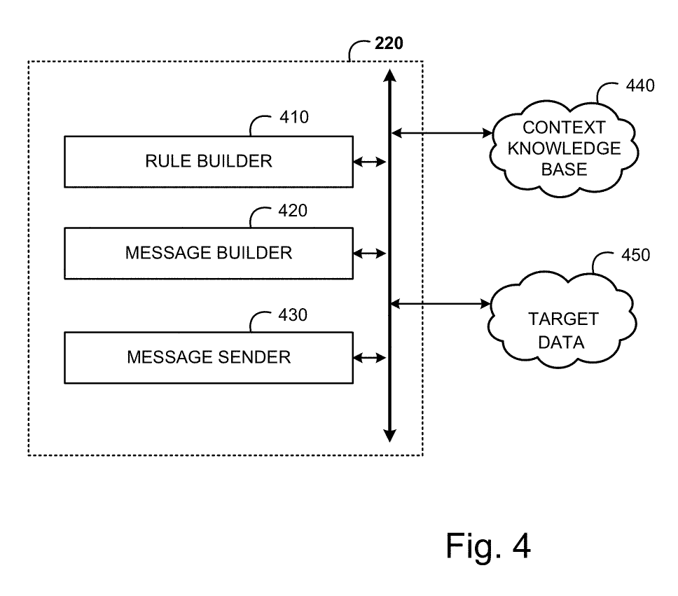

Moving on to FIG. 4, an example logical diagram of the message generator 220 is provided. The message generator 220 utilizes context knowledge 440 and target data 450 to generate the initial message. The message generator 220 includes a rule builder 410 which allows the user to define rules for the messages. A rule creation interface which allows users to define a variable to check in a situation and then alter the data in a specific way. For example, when receiving the scores from the AI, if the intent is Interpretation and the chosen category is ‘good’, then have the Continue Messaging intent return ‘continue’.

The rule builder 410 may provide possible phrases for the message based upon available target data. The message builder 420 incorporates those possible phrases into a message template, where variables are designated, to generate the outgoing message. Multiple selection approaches and algorithms may be used to select specific phrases from a large phrase library of semantically similar phrases for inclusion into the message template. For example, specific phrases may be assigned category rankings related to various dimensions such as “formal vs. informal, education level, friendly tone vs. unfriendly tone, and other dimensions,” Additional category rankings for individual phrases may also be dynamically assigned based upon operational feedback in achieving conversational objectives so that more “successful” phrases may be more likely to be included in a particular message template. This is provided to the message sender 430 which formats the outgoing message and provides it to the messaging platforms for delivery to the appropriate recipient.

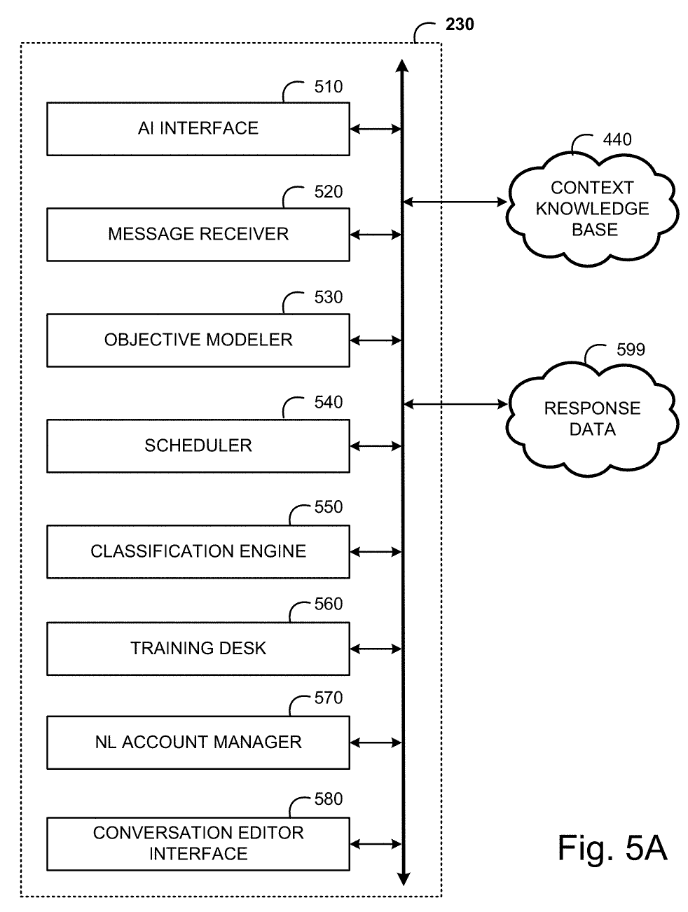

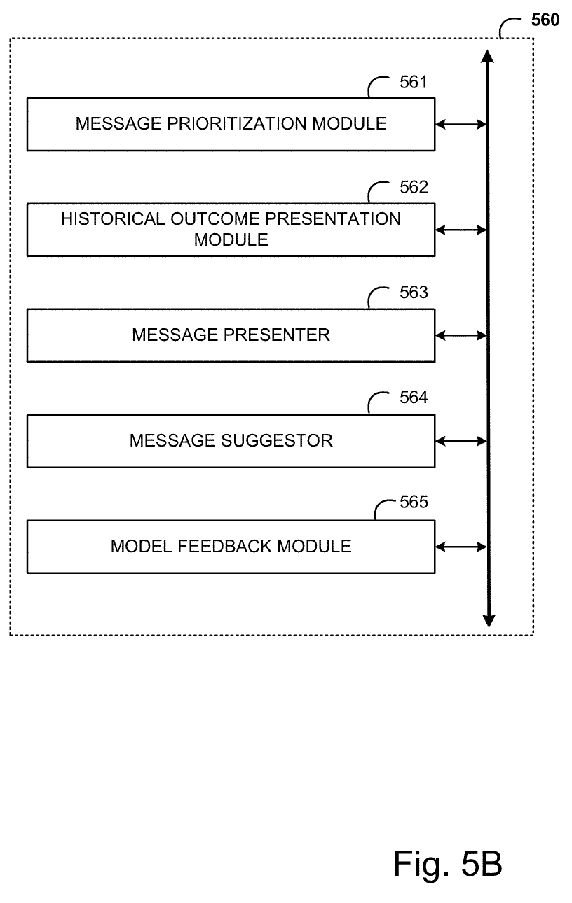

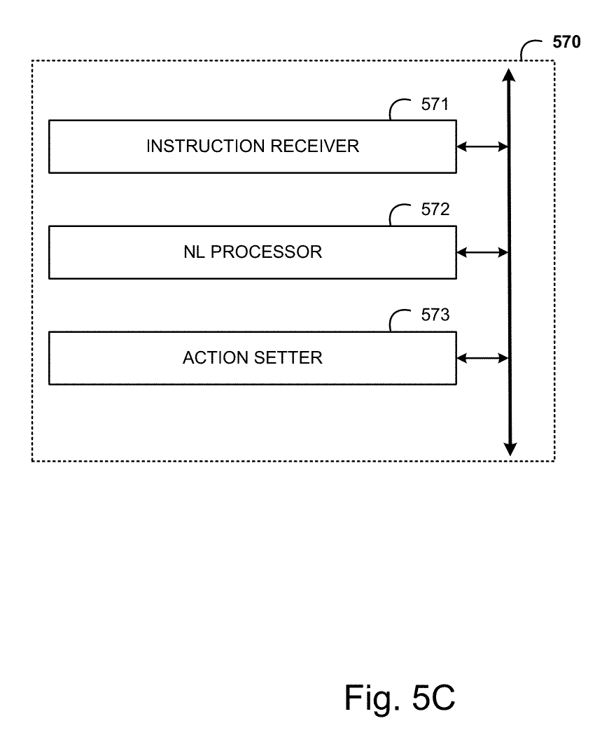

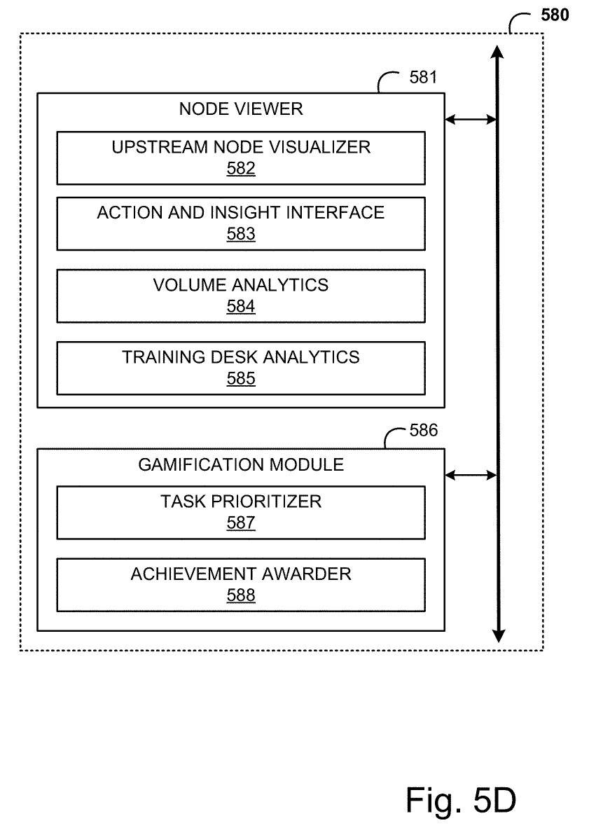

FIG. 5A is an example logical diagram of the message response system 230. In this example system, the contextual knowledge base 440 is utilized in combination with response data 599 received from the person being messaged. The message receiver 520 receives the response data 599 and provides it to the AI interface 510, objective modeler 530, and classifier engine 550 for feedback. The AI interface 510 allows the AI platform (or multiple AI models) to process the response for context, intents, sentiments and associated confidence scores. The classification engine 550 includes a suite of tools that enable better classification of the messages using machine learned models. Based on the classifications generated by the AI and classification engine 550 tools target objectives may be updated by the objective modeler 530. The objective modeler may indicate what the objective to the next action in the conversation may entail.

The training desk 560 may include data aggregation and analysis tools that enable the population of user interfaces that allow for human operator interaction in a conversation, particularly when the machine learning models lack the required level of confidence to operate automatically. Not only does the training desk allow for more seamless user interruption into the conversation (often to the point that the target on the other side is unaware of the change), but it also allows for continual real-world training of the machine learned classification models.

A natural language (NL) account manager 570 is a domain specific AI assistant that enables enhanced productivity between a customer (a business or other entity leveraging the AI messaging system) and the company that created and is implementing the conversations on behalf of the customer. This account manager assistant 570 is capable of leveraging the classification engine to consume received instructions and take appropriate actions on behalf of the message recipient. Alternatively, due to the specific domain in which the account manager assistant 570 is operating, it may even be possible to leverage basic keyword matching or other techniques to determine which action to take, rather than requiring a full classification of the message.

Lastly, a conversation editor interface 580 may enable a user of the system to readily understand how the model operates at any given node, and further enables the alteration of how the system reacts to given inputs. The conversation editor 580 may also generate and display important metrics that may assist the user in determining if, and how, a given node should be edited. For example, for a given action at the node, the system may indicate how often that action has been utilized in the past, or how often the message if referred to the training desk due to the model being unclear on how to properly respond.

Turning to FIG. 5B, the training desk 560 is illustrated in greater detail. This component is used when a message classification lacks the predicated confidence to take an action or respond in an automated fashion. The disclosed systems and methods for machine learned classification of natural language are state of the art, and represent some of the most sophisticated language AI analytics currently available. However, human speech is extremely variable and complicated for even the most advanced systems to understand. For a single topic there is a vast plethora of ways in which a human can express the concept. This includes synonym replacements, different sentence structuring, and reliance on external contextual cues. Additionally, human speech may include slang, metaphor and colloquial terms, which even if interpreted correctly may not actually convey the intention of the speaker. A simple example of this would be where the system is seeking feedback on a product and sends a message asking “What do you think of the computer you ordered?” A possible response could include “It's sick. It really screams due to the graphics card upgrade. Overall, very cool.” A machine may have an extremely difficult time differentiating that the system is not ill, but rather is a term of extreme positive sentiment for the products performance. Likewise, terms like “scream” and “cool” may be misinterpreted due to their multiple meanings; both literal and figurative.

Due to all of these complications with interpreting the messages, it is guaranteed that, on occasion, the classification system will be incapable of properly determining the classification of a particular message exchange. In these situations a human operator needs to be looped into the exchange. The training desk 560 is a vehicle to ensure the human operator is presented the proper information in a manner that maximizes efficiency. The entire purpose of the disclosed messaging system is to enable the minimization of human input, greater throughput, and the reduced need for large banks of call centers or significant customer service centers. As such, even when a human needs to be interjected into the conversation, it is desirable to make the intervention as efficient as possible.

The first thing the training desk does is to prioritize the messages. A message prioritization module 561 may analyze the messages for channel, client, and indicators of urgency in order to determine which messages that require human intervention need to be addressed first. For example, if a client is particularly valuable, or has previously been shown to be impatient, they may be prioritized above more patient, or less valuable, clients. Likewise, certain channels of communication, such as real time instant messaging or audio exchanges, may be given priority versus text messaging or email exchanges. Likewise, pendency since the last message may be employed to prioritize messages. For example, in some embodiments, a message exchange by text message is typically given priority over an email message. However, if the email message is already a few days old, it may be prioritized above a text message that is merely an hour or two old.

Likewise, message content may be leveraged in the determination of processing priority. Certain keywords, if present in the message, may raise the priority of a given message, even when the topic cannot be determined. One common example if the inclusion of terms such as “urgent” may trigger the system to prioritize a given message. Likewise, possible classification may be leveraged in order to determine priority. For example, if the classification engine thinks the message is requesting a purchase contract, but the classification confidence is less than ideal, this message may still be given a higher priority than a message where it is believed the user is merely requesting additional information.

Furthermore, some conversations and or particular nodes within the conversation may be defaulted as being more or less important. For example, a conversation related to basic customer service may be provided a lower priority that a conversation directed at established clients or new purchases.

In some embodiments, each of these factors may be considered and assigned different weights in order to determine message review priority. In a default system, channel considerations may outweigh other prioritization considerations, followed by inclusion of keywords such as “urgent” followed by conversation types, then client profile (client value and/or patience level) and lastly low confidence classifications.

After the order in which the messages will be reviewed has been determined, the system may generate a series of metrics for the message that is presented to the human operator via the historical outcome presentation module 562. These collated metrics may enable the user to make faster and more informed decisions on how to respond to the given message. For example, a histogram may be generated for previous messages the AI wasn't confident in, along with the eventual outcomes for these messages. This data may be employed by the operator to increase the accuracy of their decision making.

A message presenter 563 provides the message that requires human attention to the operator along with these metrics. This may be a raw view of the message, or may include annotation of which portions of the message are classified with an acceptable level of accuracy, versus message segments where classification confidence is below a threshold. In some embodiments, only messages with classification confidences below 95% are routed to a human operator as discussed herein. Of course this confidence threshold may be configured based upon use case, available resources, etc. For example, in some embodiments, confidences below 97% may be routed for human intervention normally, but nearing the holidays when, for this particular use case, message volumes increase significantly, it may be desirable to lower this threshold to 90% or even 85% due to the number of human operators that are available to handle messages. This will result in a slightly larger number of messages being incorrectly responded to, but still allows for messages that truly are beyond the scope of the AI to interpret to be reviewed by a human in a reasonable timeframe given staffing limitations and message volumes.

Although the messages being presented to the user are deemed to not have a sufficient confidence level by the AI model, these messages often have some classification that has been attributed to it. The AI model may be “unsure” if this is a correct classification, but in human terms the system may have a “hunch” as to the message topic, and merely needs human intervention to confirm or correct the “hunch”. In order to increase efficiency, the system may generate a suggested message based upon the action models employed by the AI. A message suggestor 564 may generate this proposed response based upon the suspected classification, and present this to the human reviewer. If the classification was indeed correct, the user may then quickly approve the suggested response, rather than drafting a response from scratch. This allows for very rapid review and response approval for a very large number of the messages that require human intervention. In practice, this may increase human operator response speed by an order of magnitude compared to responding to each message individually from scratch.

In some embodiments, the suggestions presented to the user may fall into eleven discrete categories. These may include continue messaging, skip to follow-up, stop messaging, do not email, no contacted, received contacted, action required, alert, send resources, out of office and check back later. Each of these response suggestions will be described in greater detail below. It should be noted that these eleven response suggestions are not limiting, and more or fewer actions may be available to the training desk user. These suggestions are merely presented to assist in the clarification of possible suggestions available to the user.

Continue messaging is an action used to go from a current message series to the next. This suggestion is only presented hen there is a subsequent series in the conversation to go to. This suggestion may be presented when the response was a positive response to a basic yes/no question, where the customer defines what they wish to purchase (in a sales conversation), if the target is requesting more information in order to make a decision, the target indicates they prefer a different channel of communication which is supported in a later series (such as email versus text or calls), or when a target provides a phone number when the current series is not requesting a number.

Skip to follow-up is a suggested action to move from a current series in the conversation to a series after (but not the next series). Generally this action is proposed when the target has already answered the question related to the next series of messages. This suggestion is only made available to the operator when there is a later series of messages available to jump to. This action may be proposed when the content of the current message precludes moving to the next series. For example, if the target sends a message stating “I only want to discuss this via email” and the next series would request a good phone number for the target, the system may suggest skipping the next series and going to a subsequent series of messages.

Stop messaging is an action to discontinue the conversation with the target. This action may be suggested when a target of the conversation indicates that they don't require anything further, were mistakenly contacted in the first place, that they are not interested in the information/product/service at the heart of the conversation, or when the message is gibberish, blank or randomized words.

Do not email is an action used to not only discontinue contacting the target now, but to ensure the individual is not ever contacted again, even in the context of a different conversation. This action is utilized typically when the contact message includes derogatory content, cursing or extremely aggressive content. This may also be employed if the target makes a direct request to not be contacted ever again (as opposed to temporary disinterest in the topic at hand). This action may likewise be used when the target is determined to be an ineligible contact; for example a minor, an employee of the customer or a test contact. Disambiguating between ‘stop messaging’ and ‘do not email’ may be difficult and require a qualitative judgement call based upon the exact wording by the target. Additionally, it should be noted that the term ‘email’ is used here, this action may be applied regardless of the channel being employed for contacting the target.

Not contacted is an action that may be suggested when the target indicates they were not contacted by a representative. This action results in a termination or follow-up response. Conversely, the received contact suggestion is where the target indicates they have been contacted by a representative. This also results in a termination or additional follow-up response, but a log of the interaction with a human representative may be saved for later reference.

Action required is a suggestion that may be provided where a human is required to continue interactions beyond the scope of the automated messaging system. As noted before, in some cases the messaging system is deployed by the developer of the messaging system on behalf of a customer for the purpose of communicating with targets on behalf of that customer. At some stage the scope of the conversations may extend beyond the scope of what the messaging system was configured to handle, and instead the customer representative should continue the conversation with the target directly. In such a circumstance, the human operator being employed by the messaging service provider may forward the conversation history and target data to the customer for all additional follow-up activities. This may occur when the target starts to request information regarding the name or manager of the AI system, requests contact at a specific later date, when the person indicates they have a suspicion they are conversing with a computer system as opposed to a human, the message is received in an unsupported language, or requests future communication in an unsupported language, or when the target indicates they will be contacting the customer directly.

Alert is a suggested action that sends the human representative a notice. This may be employed in a variety of configurable circumstances. For example, within the sales conversation context, if the target indicates they have already purchased an item or service the alert may be sent to the sales representative to update records or clarify the accuracy of this claim. An alert may be generated in addition to another suggested action. For example, if the individual has indicated a representative already contacted them, in addition to received contacted action being noted, the representative may also receive an alert of this activity.

Send resources is an action where information is returned in the response to the target. This response may include linked information to external information sources, embedded information, or attached information (when communication is via an email channel). This sort of action may be taken whenever a target requests a specific category of information, or expresses interest in a topic at a very elementary level.

Out of office action is a mechanism to postpone future conversation messages for a time when the target is available. While this action refers to the workplace term “office” it is intended to be employed whenever the message to a target needs to be delayed for whatever reason. In this action, a new message in the current series of messages is sent after the determined delay period. Note that while a messaging delay is employed in all situations in order to more accurately mimic typical human communication cadence, this delay is typically small—at most a day or two. The out of office action may instead impose a much more specific, and potentially much longer, delay based upon message information. Generally this action is taken when an out-of-office, vacation, or unavailable automated message is sent from the target. The delay imposed may be based upon the content of the message. For example, if the automated message does not indicate how long the target is unavailable the action may default to delay subsequent messaging by one week. If a return date is included in the out-of-office message from the target, the delay may be set for three days after the return date, thereby allowing the target time to settle before the message is sent. If the out-of-office message from the target provided a date to contact the target again, then this date may be employed for the delay period. Often these out-of-office messages may be identified as such through the subject line (when in email format), and the body of the message includes information related to timing.

Check back later action is similar to the out-of-office action, except this action is taken not for an automated message, but rather when the target indicates that communication needs to be delayed for reasons unrelated to unavailability. For example, in a business setting, some decisions are made on a monthly or quarterly basis. A target may indicate this, and the system may delay additional contact for the requisite time based upon the target's suggestion. After the delay period, the system may send the next series of messages. Check back later is employed when the message from the target is not automated, indicates some level of interest, and indicates a date, or delay time period, before they should be contacted again. Some common time translations are as follows: “next year” would be January 5^{th} of the following year, “end of the month” would be the first of the following month, “end of spring/summer/fall/winter” would be March 20^{th}, June 20^{th}, September 23^{rd} and December 21^{st}, respectively, “next week” would be the following Monday, and “the end of the week” would be Friday.

Moving on, based upon what action the user takes, the system may take this feedback and update the machine learned model accordingly via a model feedback module 565. For example, if the user agrees with the classification that was originally determined by the classification engine, similar language in a future message may be classified with greater confidence. Likewise, if the user rejects the classification and provides an alternate response, the system may analyze the response to determine what classification would have been appropriate for the original message. For example, if the message stated “I appreciate the additional information, I'll get back to you” in some embodiments the AI model may classify the message as “requiring additional information”. This is obviously an incorrect classification, and the human operator may instead write back “Sounds good, we will contact you next week.” This response is how the system would respond to a classification of “follow-up in X timeframe.” By working backwards, the system may determine that the original classification was incorrect, lowering the confidence for such a classification the next time such an exchange is encountered. Likewise, a classification of follow-up required would be associated with this type of exchange.

FIG. 5C provides an example diagram of the natural language account manager assistant 570. This system component includes a receiver module 571 for receiving instructions from a customer, which are then processed via a natural language processor 572. This processor may include a basic keyword matching for common instructions, or may leverage the more sophisticated classification and natural language processing backbone employed by the messaging system as disclosed herein. The NL assistant 570 may also include an action setter 573 that has access to calendars, email accounts and other systems that may execute the desired actions.

For example, if a representative receives a message from a client that states “Rachel, tell the lead “Carl will call you tomorrow at 10 am”” the system may be enabled to decipher that an instruction has been sent. This instruction is to tell the lead/target that “Carl will call you at 10 am”. The system may have access to the representative's email system and generate the necessary message to the target with this information. The system may also classify the instructions sent that a meeting at 10 am is to occur between the target and Carl. This may trigger an action to place a reminder on the representative's calendar with a reminder of the meeting, and if the earlier context of the discussions is able to disambiguate who Carl refers to, may also include this individual on the calendar invitation so that he is likewise reminded to the upcoming meeting.

This functionality is enabled by the NL account manager assistant 570 having access to these other systems, and also its ability to have persistent memory across all actions and communications that the representative has. The natural language account manager assistant 570 may additionally have access to all supported channels by which instructions are sent, including email, SMS, mobile user interfaces, web based accounts and the like.

Turning to FIG. 5D, the conversation editor 580 is shown. The conversation editor is a consolidated user interface that enables the visualization and modification of details regarding the conversation, and further includes interfaces and systems to modify user behaviors to increase system efficacy. This system comprises two distinct sub-components, including the node viewer 581 and a gamification module 586. The node viewer 581 includes functionality for viewing upstream nodes 582, an interface for actions and intents 583, a volume analytics module 584, and training desk analytics module for the displayed node 585.

The upstream node visualizer 582 illustrates the primary question being asked at the given conversation node, as well as the questions being asked at upstream nodes. These primary questions may be a single “prototypical” version of the question being asked, or multiple variants of the question being asked. The action and intent interface 583 may display the full listing of actions that the system may take at the given node, and examples of what the AI is “looking for” that correspond to each action. For the purpose of this component, these example inputs that result in a particular action are referred to as “intents”. The volume analytics module 584 provides the user information related to the number of messages that have passed through the given node in a selectable time period, whereas the training desk analytics module 585 provides information regarding the percentage of messages at the node that are referred to the training desk operator, as well as the percentage of messages that are deemed incorrect when sent through an audit process. The percentage of messages sent to a human operator indicates how confident, overall, the AI is in the classifications at the given node. The percentage of instances being corrected at audit indicates the rate of error in the AI even when it is confident in the classification. Additionally, this module may determine the audit performance for messages that have been provided to a human operator. A large error rate for this metric may indicate that the messages being received at this node are actually tricky to understand, and may suggest that a better message series may be required to elicit clearer responses from the targets.

The gamification module 586 may include a task prioritizer 587 and an achievement awarder 588. The gamification module includes the logic behind the issuance of achievements and awards, along with a user interface for presentation of these achievements. The purpose of this module is to elicit, from a human user, the information required to enable the AI messaging system to operate in an effective manner. The task prioritizer 587 determines what tasks are required for system operation, and assigns these top priorities. For example, the inputting of fundamental contact information, basic conversation rules, and a base number of targets is all necessary to have any successful conversations. These tasks may be assigned a high priority, and have suitable achievements associated with their completion. Non necessary tasks may then be analyzed for their relative impact and prioritized accordingly. For example the addition of twenty additional targets may improve the messaging systems ability to achieve a goal by a significant amount. As such, the addition of twenty more targets for conversation may be afforded an achievement award. Likewise, uploading product details and service information specific to the user may have a slightly smaller, but still significant impact on system performance. This may then be assigned another award type. The system may however, suffer from diminished returns after the first twenty targets, so additional achievements for providing more target information may be limited until higher priority tasks have been completed, in this example embodiment.

After the user completes any of the tasks that have an award associated with it, the award may be presented to the user by the achievement awarder 588. This may include the usage of digital “badges” that are displayed on a trophy interface, or may have more tangible awards, such as gift cards, cash bonuses, personalized notes, or modulation of a user's employee review results.

Although not illustrated here, the set of user interfaces that include the node analyzer and gamification interface may additionally include a metrics interface that collates various benchmarks across industry, segment and even specific manufacturers. These metrics may be made available to the user on a dashboard for assisting in generating messaging conversations, altering existing conversations, and understanding impacts caused by automated messaging. The metrics displayed may include engagement statistics and statistics for a given deal. These statistics may be split by conversation, industry, channel and target. The purpose of metric display is to enhance customer understanding on what conversations and strategies are lagging or beating the average performance in these categories. This may then inform future conversation types, channels and rollout strategies.

Another way benchmark data may be leveraged is to provide information on the source of the target. For example, within the automotive industry the sources of potential car buyers are distinct. They may be people who have entered into a contest, entered a dealership and provided information, performed a search online for vehicles, or may be aggregated from prior customer lists (for example a customer from ten years ago who may be in the market for a new vehicle soon). These target sources may be compared against one another in light of the industry, channel and conversation type. Engagement rates, hot-lead rates, lead at risk metrics, and close rates may all be tracked. This may be benchmarked against other dealer information in the same geographic location, normalized by their target source. Differences in metrics that are statistically significant (e.g., over one or two orders of deviation different) may be noted, and future targeting of lead sources, or different conversation strategies, may be adopted in the future to improve conversation performance (e.g., increasing “good” metrics like engagement and close rates, while reducing “negative” metrics like customers at risk). Another example would be benchmarking clients who are distributors for an OEM,

### II. Methods

Now that the systems for dynamic messaging, training desk, conversation editor, and NL account management have been broadly described, attention will be turned to processes employed to perform AI driven conversations, as well as example processes for enhanced human interaction with AI messaging systems for human intervention in messaging, as well as conversation editing and task completion.

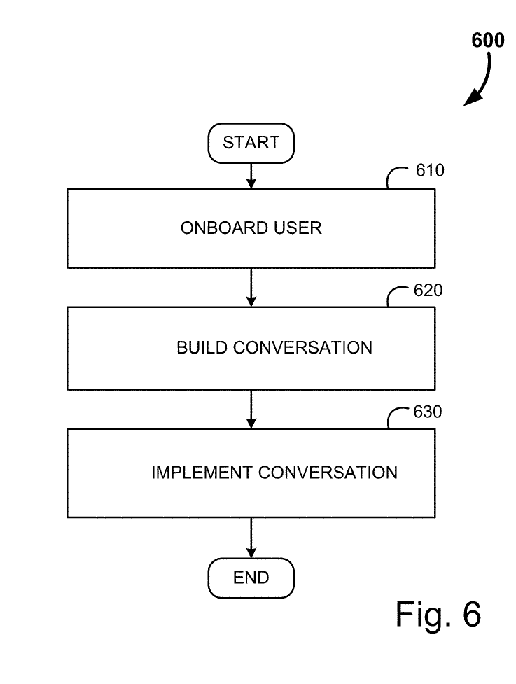

In FIG. 6 an example flow diagram for a dynamic message conversation is provided, shown generally at 600. The process can be broadly broken down into three portions: the on-boarding of a user (at 610), conversation generation (at 620) and conversation implementation (at 630). The following figures and associated disclosure will delve deeper into the specifics of these given process steps.

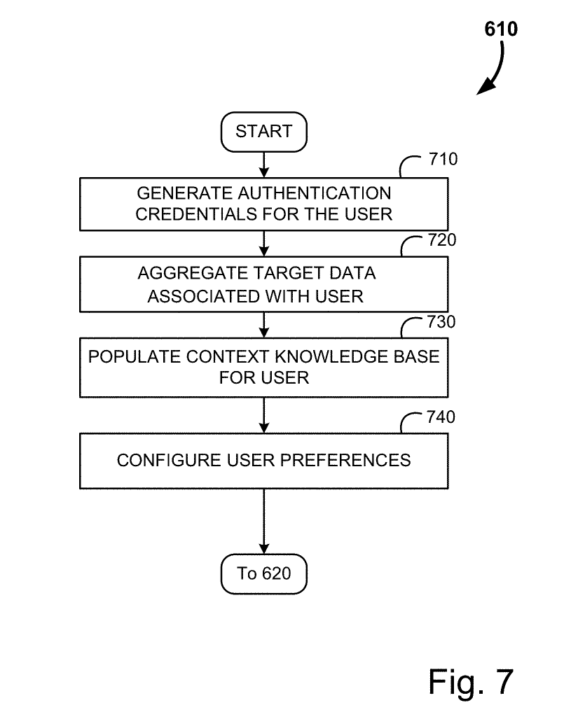

FIG. 7, for example, provides a more detailed look into the on-boarding process, shown generally at 610. Initially a user is provided (or generates) a set of authentication credentials (at 710). This enables subsequent authentication of the user by any known methods of authentication. This may include username and password combinations, biometric identification, device credentials, etc.

Next, the target data associated with the user is imported, or otherwise aggregated, to provide the system with a target database for message generation (at 720). Likewise, context knowledge data may be populated as it pertains to the user (at 730). Often there are general knowledge data sets that can be automatically associated with a new user; however, it is sometimes desirable to have knowledge sets that are unique to the user's conversation that wouldn't be commonly applied. These more specialized knowledge sets may be imported or added by the user directly.

Lastly, the user is able to configure their preferences and settings (at 740). This may be as simple as selecting dashboard layouts, to configuring confidence thresholds required before alerting the user for manual intervention.

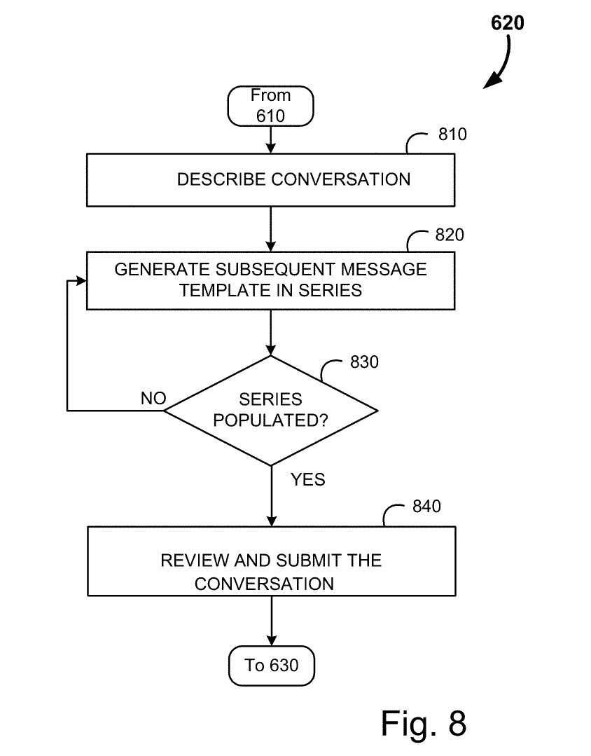

Moving on, FIG. 8 is the example flow diagram for the process of building a conversation, shown generally at 620. The user initiates the new conversation by first describing it (at 810). Conversation description includes providing a conversation name, description, industry selection, and service type. The industry selection and service type may be utilized to ensure the proper knowledge sets are relied upon for the analysis of responses.

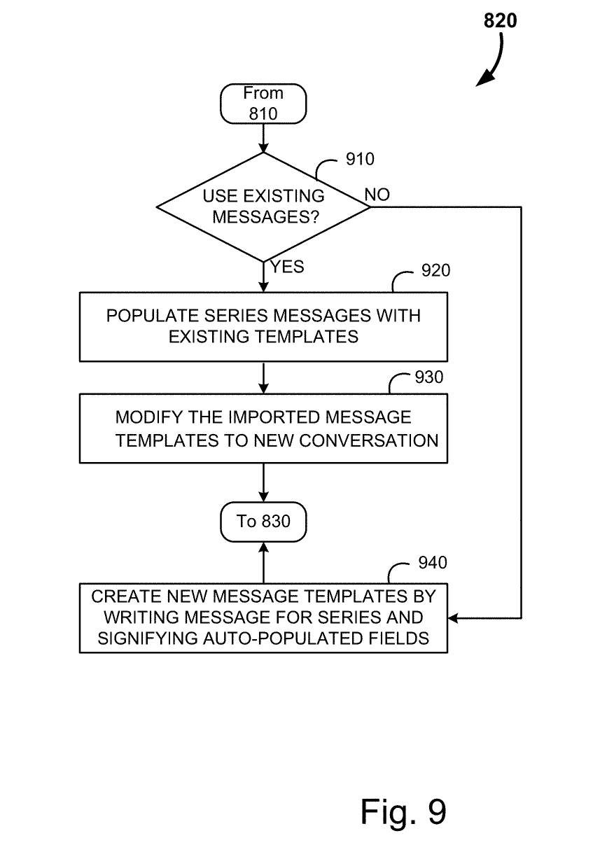

After the conversation is described, the message templates in the conversation are generated (at 820). If the series is populated (at 830), then the conversation is reviewed and submitted (at 840). Otherwise, the next message in the template is generated (at 820). FIG. 9 provides greater details of an example of this sub-process for generating message templates. Initially the user is queried if an existing conversation can be leveraged for templates, or whether a new template is desired (at 910).

If an existing conversation is used, the new message templates are generated by populating the templates with existing templates (at 920). The user is then afforded the opportunity to modify the message templates to better reflect the new conversation (at 930). Since the objectives of many conversations may be similar, the user will tend to generate a library of conversations and conversation fragments that may be reused, with or without modification, in some situations. Reusing conversations has time saving advantages, when it is possible.

However, if there is no suitable conversation to be leveraged, the user may opt to write the message templates from scratch using the Conversation Editor (at 940). When a message template is generated, the bulk of the message is written by the user, and variables are imported for regions of the message that will vary based upon the target data. Successful messages are designed to elicit responses that are readily classified. Higher classification accuracy enables the system to operate longer without user interference, which increases conversation efficiency and user workload.

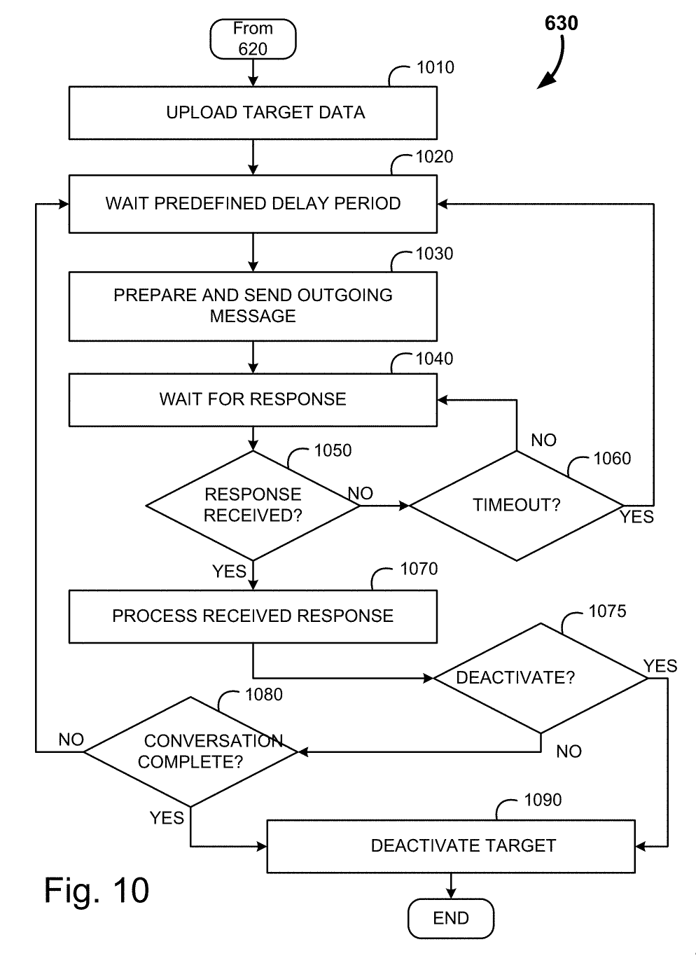

Once the conversation has been built out it is ready for implementation. FIG. 10 is an example flow diagram for the process of implementing the conversation, shown generally at 630. Here the lead (or target) data is uploaded (at 1010). Target data may include any number of data types, but commonly includes names, contact information, date of contact, item the target was interested in (in the context of a sales conversation), etc. Other data can include open comments that targets supplied to the target provider, any items the target may have to trade in, and the date the target came into the target provider's system. Often target data is specific to the industry, and individual users may have unique data that may be employed.

An appropriate delay period is allowed to elapse (at 1020) before the message is prepared and sent out (at 1030). The waiting period is important so that the target does not feel overly pressured, nor the user appears overly eager. Additionally, this delay more accurately mimics a human correspondence (rather than an instantaneous automated message). Additionally, as the system progresses and learns, the delay period may be optimized by the cadence optimizer to be ideally suited for the given message, objective, industry involved, and actor receiving the message. This cadence optimization is described in greater detail later in this disclosure.

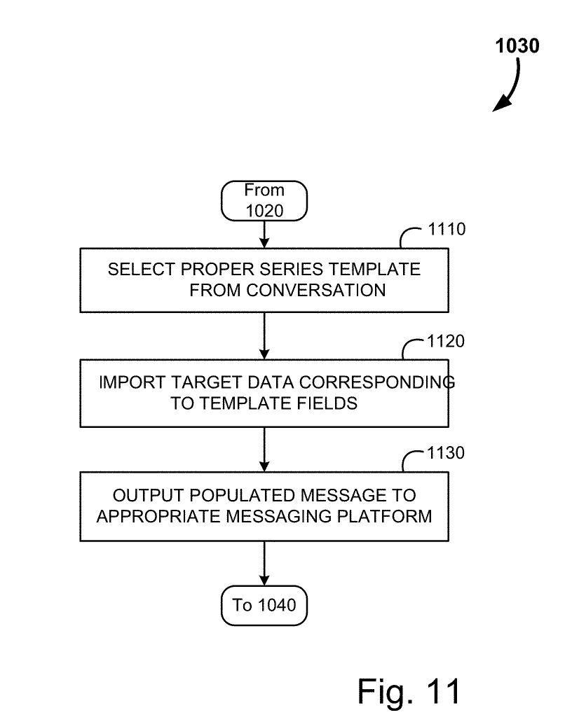

FIG. 11 provides a more detailed example of the message preparation and output. In this example flow diagram, the message within the series is selected based upon which objectives are outstanding (at 1110). Typically, the messages will be presented in a set order; however, if the objective for a particular target has already been met for a given series, then another message may be more appropriate. Likewise, if the recipient didn't respond as expected, or not at all, it may be desirous to have alternate message templates to address the target most effectively.

After the message template is selected from the series, the target data is parsed through, and matches for the variable fields in the message templates are populated (at 1120). The populated message is output to the communication channel appropriate messaging platform (at 1130), which as previously discussed typically includes an email service, but may also include SMS services, instant messages, social networks, audio networks using telephony or speakers and microphone, or video communication devices or networks or the like. In some embodiments, the contact receiving the messages may be asked if he has a preferred channel of communication. If so, the channel selected may be utilized for all future communication with the contact. In other embodiments, communication may occur across multiple different communication channels based upon historical efficacy and/or user preference. For example, in some particular situations a contact may indicate a preference for email communication. However, historically, in this example, it has been found that objectives are met more frequently when telephone messages are utilized. In this example, the system may be configured to initially use email messaging with the contact, and only if the contact becomes unresponsive is a phone call utilized to spur the conversation forward. In another embodiment, the system may randomize the channel employed with a given contact, and over time adapt to utilize the channel that is found to be most effective for the given contact.

Returning to FIG. 10, after the message has been output, the process waits for a response (at 1040). If a response is not received (at 1050) the process determines if the wait has been timed out (at 1060). Allowing a target to languish too long may result in missed opportunities; however, pestering the target too frequently may have an adverse impact on the relationship. As such, this timeout period may be user defined and will typically depend on the communication channel. Often the timeout period varies substantially, for example for email communication the timeout period could vary from a few days to a week or more. For real-time chat communication channel implementations, the timeout period could be measured in seconds, and for voice or video communication channel implementations, the timeout could be measured in fractions of a second to seconds. If there has not been a timeout event, then the system continues to wait for a response (at 1050). However, once sufficient time has passed without a response, it may be desirous to return to the delay period (at 1020) and send a follow-up message (at 1030). Often there will be available reminder templates designed for just such a circumstance.

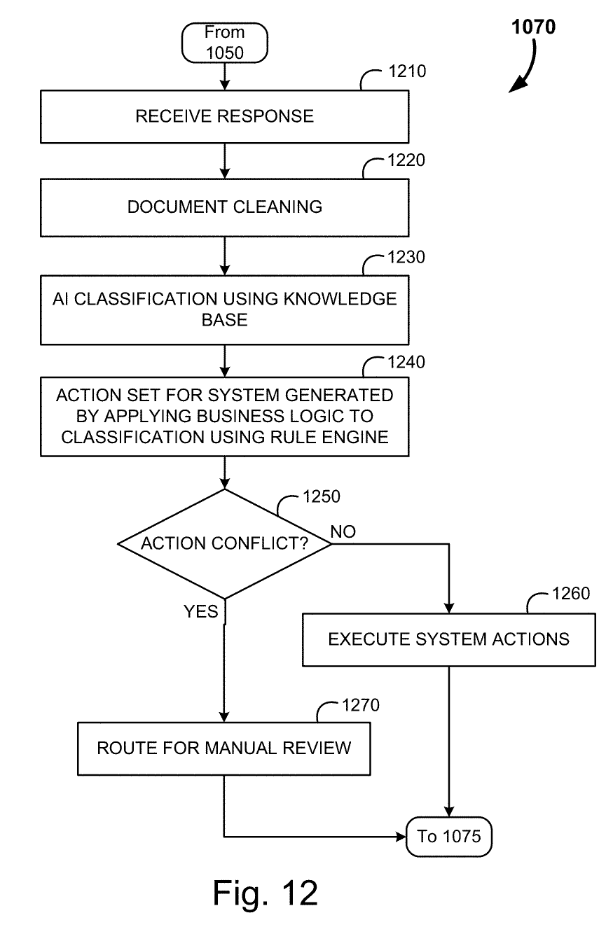

However, if a response is received, the process may continue with the response being processed (at 1070). This processing of the response is described in further detail in relation to FIG. 12. In this sub-process, the response is initially received (at 1210) and the document may be cleaned (at 1220).

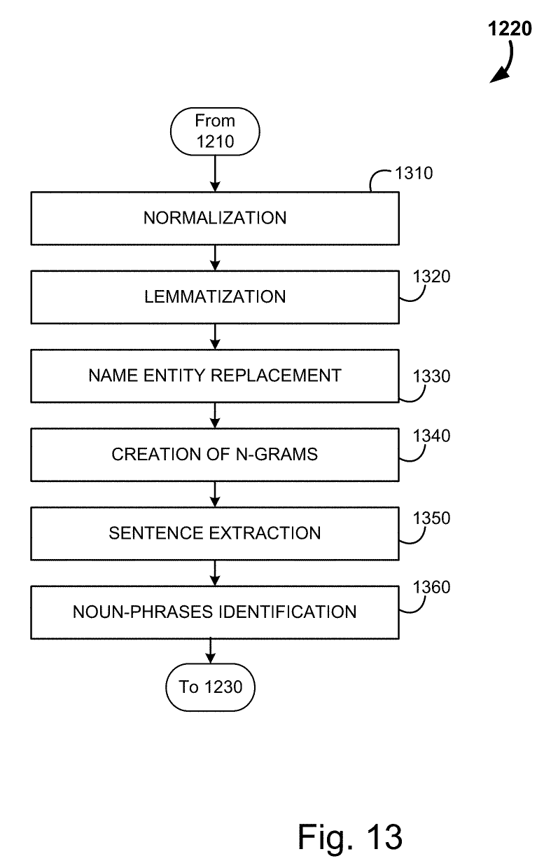

Document cleaning is described in greater detail in relation with FIG. 13. Upon document receipt, adapters may be utilized to extract information from the document for shepherding through the cleaning and classification pipelines. For example, for an email, adapters may exist for the subject and body of the response, often a number of elements need to be removed, including the original message, HTML encoding for HTML style responses, enforce UTF-8 encoding so as to get diacritics and other notation from other languages, and signatures so as to not confuse the AI. Only after all this removal process does the normalization process occur (at 1310) where characters and tokens are removed in order to reduce the complexity of the document without changing the intended classification.

After the normalization, documents are further processed through lemmatization (at 1320), name entity replacement (at 1330), the creation of n-grams (at 1340) sentence extraction (at 1350), noun-phrase identification (at 1360) and extraction of out-of-office features and/or other named entity recognition (at 1370). Each of these steps may be considered a feature extraction of the document. Historically, extractions have been combined in various ways, which results in an exponential increase in combinations as more features are desired. In response, the present method performs each feature extraction in discrete steps (on an atomic level) and the extractions can be “chained” as desired to extract a specific feature set.

Returning to FIG. 12, after document cleaning, the document is then provided to the AI platform for classification using the knowledge sets (at 1230). For the purpose of this disclosure, a “knowledge set” is a corpus of domain specific information that may be leveraged by the machine learned classification model. The knowledge sets may include a plurality of concepts and relationships between these concepts. It may also include basic concept-action pairings.

The system initially applies natural language processing through one or more AI machine learning models to process the message for the concepts contained within the message. As previously mentioned, there are a number of known algorithms that may be employed to categorize a given document, including Hardrule, Naïve Bayes, Sentiment, neural nets including convolutional neural networks and recurrent neural networks and variations, k-nearest neighbor, other vector based algorithms, etc. to name a few. In some embodiments, the classification model may be automatically developed and updated as previously touched upon, and as described in considerable detail below as well. Classification models may leverage deep learning and active learning techniques as well, as will also be discussed in greater detail below.

After the classification has been generated, the system renders intents from the message. Intents, in this context, are categories used to answer some underlying question related to the document. The classifications may map to a given intent based upon the context of the conversation message. A confidence score, and accuracy score, are then generated for the intent. Intents are used by the model to generate actions.

Objectives of the conversation, as they are updated, may be used to redefine the actions collected and scheduled. For example, ‘skip-to-follow-up’ action may be replaced with an ‘informational message’ introducing the sales rep before proceeding to ‘series 3’ objectives. Additionally, ‘Do Not Email’ or ‘Stop Messaging’ classifications should deactivate a target and remove scheduling at any time during a target's life-cycle. Intents and actions may also be annotated with “facts”. For example, if the determined action is to “check back later” this action may be annotated with a date ‘fact’ that indicates when the action is to be implemented.

Returning to FIG. 12, the actions received from the inference engine may be set (at 1240). A determination is made whether there is an action conflict (at 1250). Manual review may be needed when such a conflict exists (at 1270). Otherwise, the actions may be executed by the system (at 1260).

Returning to FIG. 10, after the response has been processed, a determination is made whether to deactivate the target (at 1075). Such a deactivation may be determined as needed when the target requests it. If so, then the target is deactivated (at 1090). If not, the process continues by determining if the conversation for the given target is complete (at 1080). The conversation may be completed when all objectives for the target have been met, or when there are no longer messages in the series that are applicable to the given target. Once the conversation is completed, the target may likewise be deactivated (at 1090).

However, if the conversation is not yet complete, the process may return to the delay period (at 1020) before preparing and sending out the next message in the series (at 1030). The process iterates in this manner until the target requests deactivation, or until all objectives are met. This concludes the main process for a comprehensive messaging conversation. Attention will now be focused on processes for human interactions with the AI system. Such human to AI cooperation enables the AI system to operate for effectively, as well as improving efficiencies for the human operators.

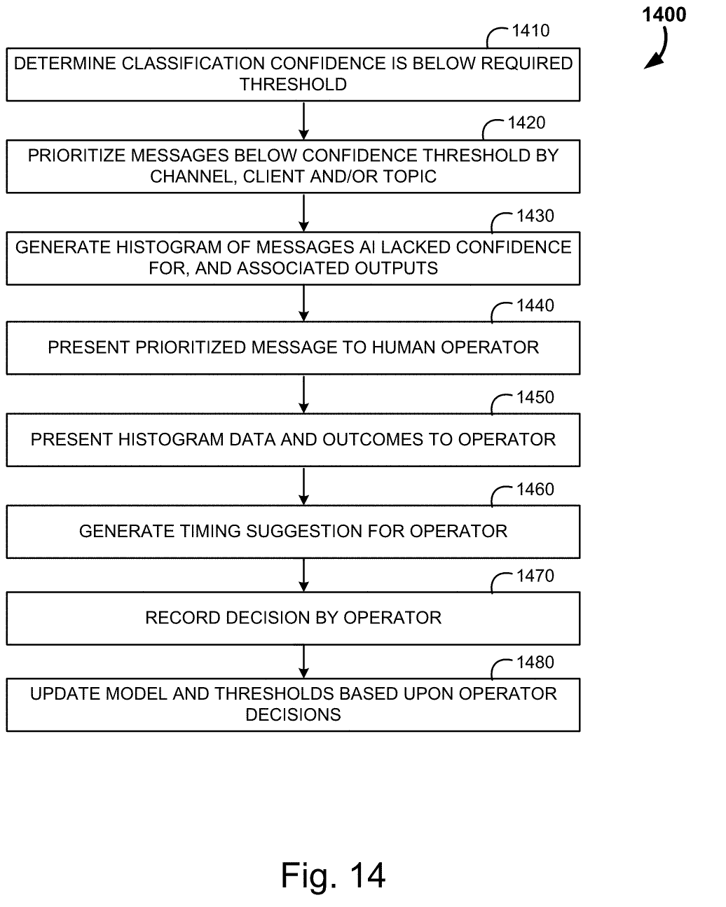

Particularly, turning to FIG. 14, a process 1400 for routing and presentation of messages at a training desk is provided, in accordance with some embodiment. As previously noted, the leveraging of a training desk is twofold: it provides a mechanism for continual model improvement using real world data with human feedback, and secondly it provides for a safety mechanism hen human input into a conversation is required due to model uncertainty. This process initially starts with conversation messages being classified, as noted earlier, and a confidence measure being determined for the classification. This confidence is then compared to a threshold, and messages with too low of confidence are slated for review by the training desk (at 1410). In many situations, this confidence threshold is set at 95%. At this level, the vast amount of classifications not requiring human review are accurately classified, and the workload required by the human operators is manageable. However this threshold may vary significantly due to a number of factors. Model quality and accuracy may impact what confidence threshold is deemed acceptable. Likewise importance of a given client being conversed with, the nature of the conversation, or staffing resources may all impact what the confidence threshold is set at. For example, for very high valued transactions the confidence threshold may be set higher, say at 99%, due to the large sums at stake. Likewise, for very high-value clients (suppose those with historical spend on upwards of $50,000) a higher confidence threshold may be desired. In contrast, for less valuable interactions, or when human operators are scarce, a lower threshold may be considered acceptable.

Regardless of confidence threshold, when messages are determined to be below this level, they may be routed for human review. This starts with the initial prioritization of the messages (at 1420) by channel, client, topic, presence of keywords indicating urgency, status of the conversation, etc. As noted previously, for any given messaging exchange, these factors may be weighted and averaged to determine message priority. Alternatively, in some embodiments only a subset of these factors may be employed for message prioritization. Moreover, in yet other embodiments, only one or a subset of factors may determine priority, and only if all factors are equal are alternate factors used to determine priority. For example, in some embodiment, priority may be based solely upon channel of communication. For to messages using the same channel (email for example) then priority depends upon client and message topic, in this example.

After message prioritization, histograms of messages that the AI lacked confidence for, and the ultimate output/result of these messages may be generated (at 1430) for search and display to a human operator. The message itself may likewise be displayed to the human operator (at 1440). This displayed message may be presented alone, with annotation, and/or in a larger transcript of the conversation with the target for greater context. The histogram which was generated previously is likewise presented to the operator (at 1450) to assist in the operators determination of an appropriate action to take.

Suggestions may be presented to the user based upon the non-confident classifications. These suggestions may include continue messaging, skip to follow-up, stop messaging, do not email, no contacted, received contacted, action required, alert, send resources, out of office and check back later, as discussed in considerable detail previously. Additionally, timing suggestions for the operator's actions may be generated and presented (at 1460). In some embodiments, any actions performed by the operator may be delayed based upon the timing suggestions. All decisions by the operator are recorded (at 1470) and are used to update the machine learning model (at 1480). In this manner the ambiguity in how to respond to a message were the classification was unsure is resolved by a human operator in a relatively seamless manner, and without significant investment or effort on behalf of the human operator. Simultaneously, the AI models are being improved, allowing for more automated responses in the future due to improved confidence scores.

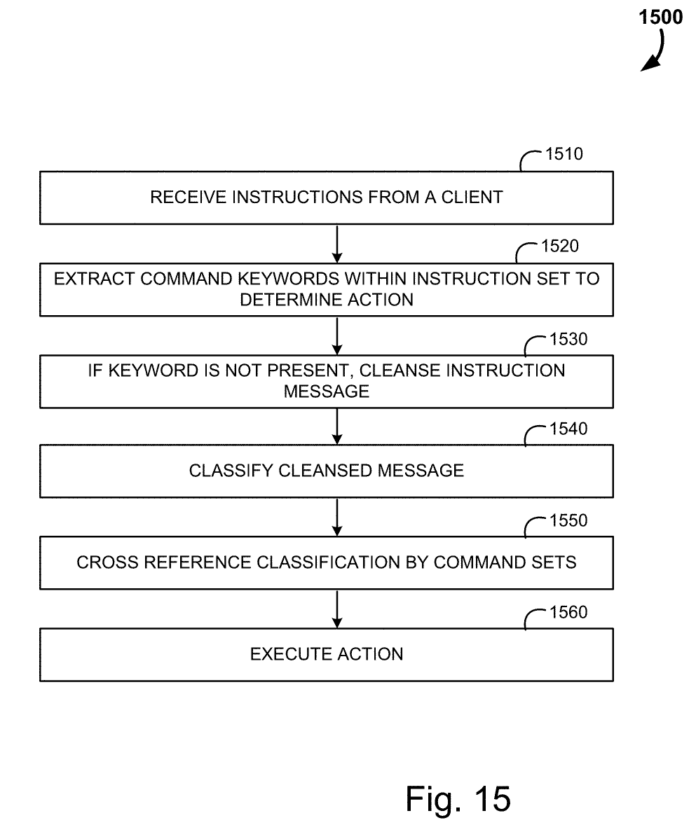

FIG. 15 is an example flow diagram for the process 1500 of the natural language account management via an AI assistant, in accordance with some embodiment. As noted previously, many of the natural language processing techniques described previously for the purpose of engaging a target in conversation may be utilized to distinguish instructions and actions that should be taken by a human, and with proper access to email and calendar systems, can allow for the automation of particular tasks. This activity of identifying instructions and executing actions based upon them is rendered more reliable and easily completed when in a specific domain. For the purpose of this disclosure, the AI assistant contemplated is for a representative of the message system provider company. Within this specific domain there are relatively few and discrete common instructions given, and these routine and repetitive instructions may be identified, and tasks done to execute them by an AI assistant. Even if only a handful of the most common instructions are identifiable and acted upon, this may result in a significant workload reduction for the representative.

For example, a common request for the representative is to schedule or convey to a target that a human salesperson or customer service technician will contact the target on a given day or time. An example of such an exchange was provided previously. Such an instruction is not difficult to understand, and can often be identified through keyword matching and/or the classification methodologies discussed previously. The action of sending a message to the target and/or generating a calendar entry for the meeting is again, relatively trivial. However, given the large volume a typical representative receives of this kind of instruction, automating the response to these instructions could result in significant time savings for the representative.

The process may either employ identification of command keywords (at 1520) which indicate what action needs to be performed, or may include utilization of a classification system; whereby the instructions are cleansed (at 1530), classified (at 1540, and rules applied to a command set (at 1550). In some embodiments, one or the other system may be employed to determine what instruction (if any) is being given to the representative. Alternatively, the systems may operate in tandem, and when keywords are not present, more computationally burdensome classification methods are employed to determine commands. Regardless, once an instruction has been determined, the process may conclude by execution of the command (at 1560). This often includes performing actions such as sending a particular target a specific message, setting up calendar events, forwarding information, or the like.

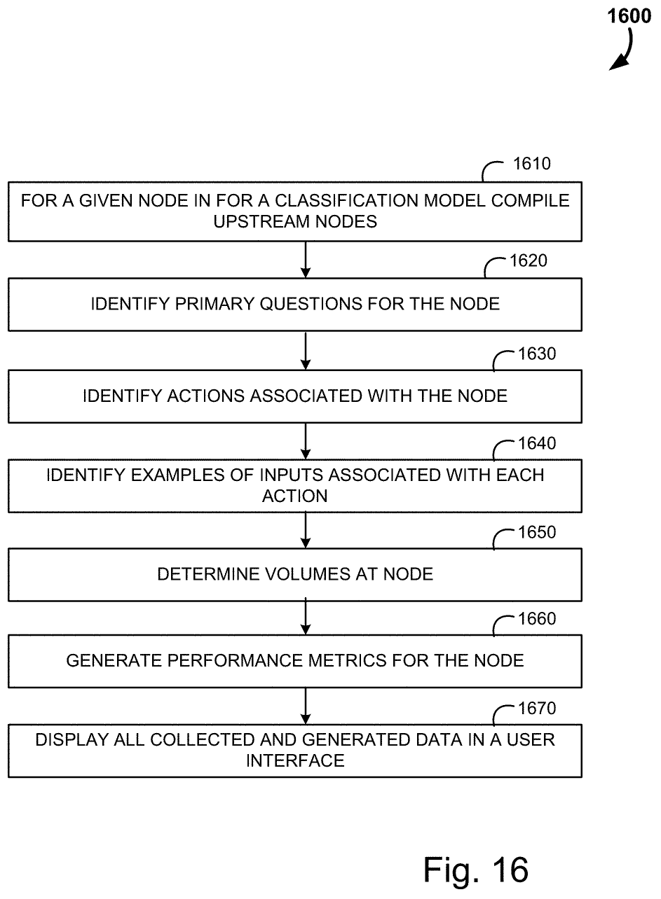

FIG. 16 is an example flow diagram for the process 1600 of generating a conversation editor interface, in accordance with some embodiment. The conversation editor interface includes displaying metrics for a specific node in a conversation decision tree, and likewise displaying upstream node information. In this process, for a given node being analyzed by a user, the upstream nodes are determined via the classification model (at 1610). The primary/prototypical question for the node is displayed (at 1620). Alternatively, a series of possible questions for the node may be presented. The actions that may be taken by the automated system, or by a human intervention via the training desk, are also identified (at 1630). Example inputs that would result in each of the actions are likewise identified (at 1640). These inputs are messages a target could provide that would result in the specific action. Volumes of messages analyzed at each node (at a650), and performance metrics for the given node (at 1660) are also determined. Performance metrics may include percentage of messages that are sent to the training desk, percentage of messages in error as determined via audits, and percentage of training desk decisions determined to be erroneous at audit. These metrics indicate how confident the model is at the node, the rate of error of the models, and difficulty of interpreting the messages at that node, respectively.

Lastly, after all of these metrics, node questions and actions and intents have been determined, the system may populate a user interface with this data (at 1670) for easy human consumption. In some embodiments, any elements of this display may also be made editable by the user, especially actions and downstream nodes, in order to influence conversation progression.

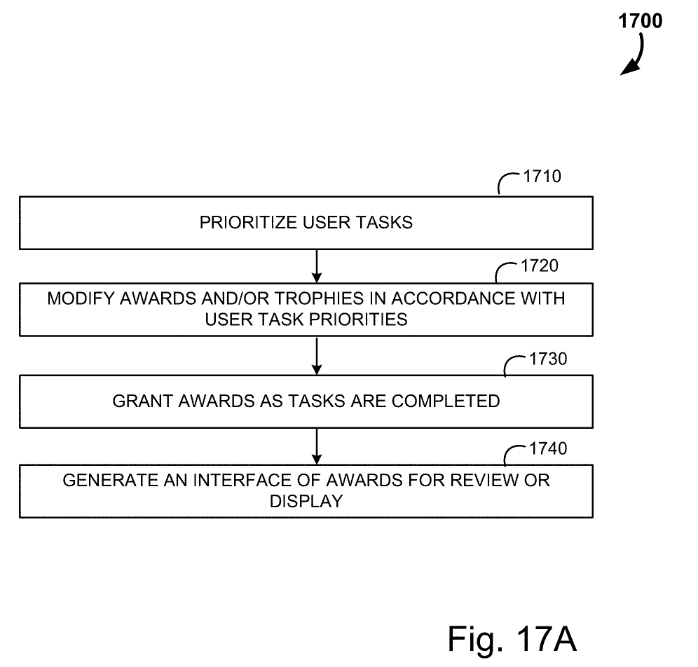

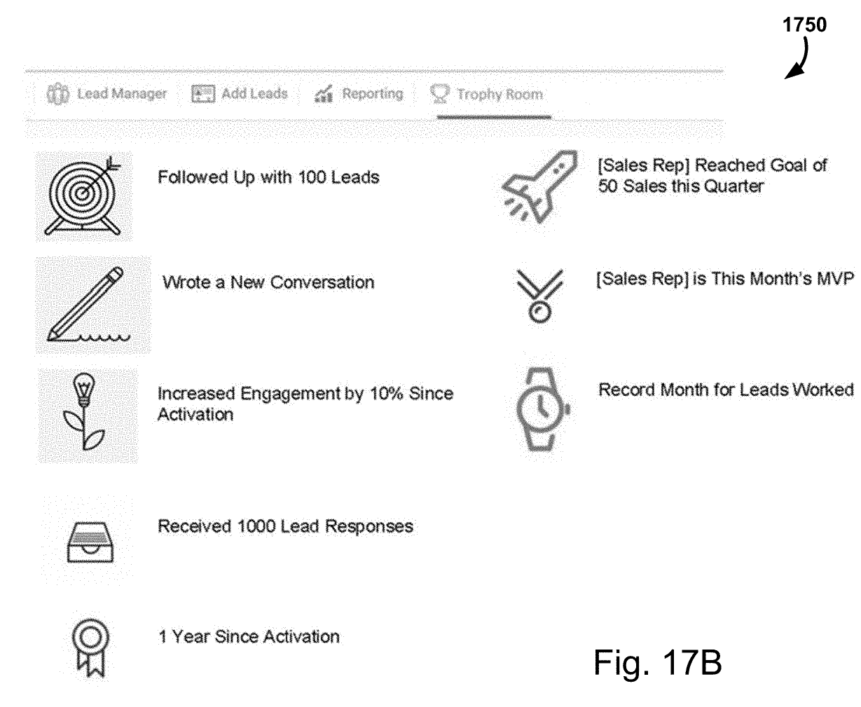

Moving on, FIG. 17A is an example flow diagram for the process 1700 of task gamification, in accordance with some embodiment. Gamification is a well-known process of applying game mechanics into an existing system to modify engagement and behavior. A particular process of gamification may be employed for the enhancement of the messaging system's operation. The AI systems discussed herein are dependent upon human engagement in order to function properly. Information that is proprietary, or only known to specific individuals, is often required for the AI systems to operate. The provider of the AI systems is often employed by customers which have access to this domain specific information. This generates a unique problem where the AI system administrator and hosting entity is beholden to the customer, and can exert very little direct influence over employees to provide the required input. Yet concurrently, if the AI messaging systems fail to perform to expectations, the AI hosting company is blamed for the shortcomings, even if they are due to inadequate data input by the customer.

In order to address this particular quandary, gamification principles may be applied to motivate the individuals capable of completing the necessary tasks. Initially the tasks are prioritized (at 1710) by necessary tasks for system operation, and then by task impact on system performance. The awards and/or trophies associated with the tasks may then be individualized to reflect the relative importance of the task (at 1720). As noted previously, these awards may include digital badges or more tangible rewards. Task completion may likewise be a factor utilized for performance reviews and as a factor for compensation decisions and career advancement opportunities.

As tasks are completed by the user they may be awarded (at 1730) and relative priorities of the remaining tasks may be periodically updated. The awards may be displayed in an interface for the user (at 1740). An example of one such interface is provided at 1750 in relation to FIG. 17B. As can be seen in this example dashboard the particular individual has followed-up with a given number of leads, generated a new conversation template, increased engagement with targets by a certain percentage, received a certain number of responses through conversations managed by this individual, has used the system for a milestone time period, reached a given quarterly objective, received additional recognition in the workplace, and beat previous ‘bests’ in a metric of targets engaged with. This set of awards, while illustrative, is not intended to be limiting. Additional or alternate awards may be achievable in a given system based upon needs of the customer, and operational impact on the AI messaging system.

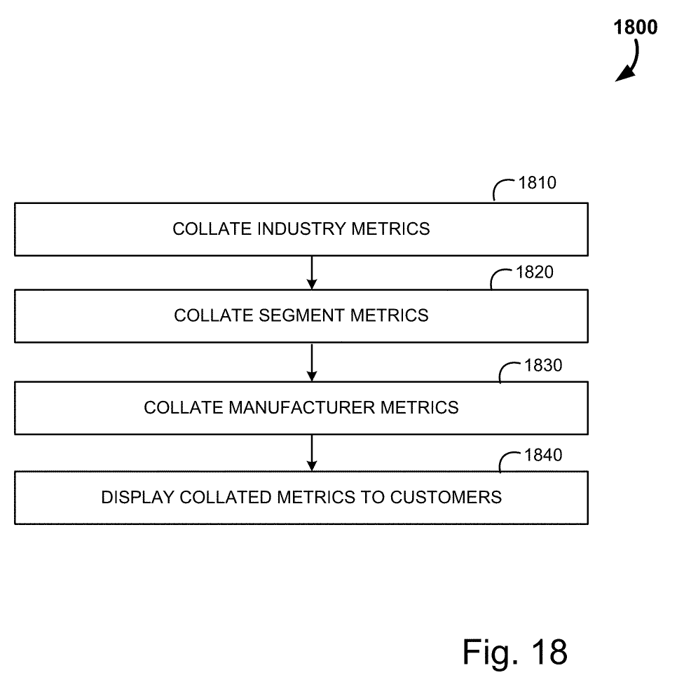

Moving on, FIG. 18 is an example flow diagram for the process 1800 of metric generation and reporting, in accordance with some embodiment. As noted, metrics may be employed to fashion new conversation templates, or augment existing messaging conversations. The metrics are initially collected for the industry (at 1810), segment (at 1820) and for a given manufacturer/brand/supplier/distributor (at 1830). The metrics once collected are displayed in their raw form (at 1840) or may be subjected to additional analytics for greater context. For example, metrics aggregation and display are necessary for downstream processing such as benchmarking clients, dealers, or specific customers as discussed previously.

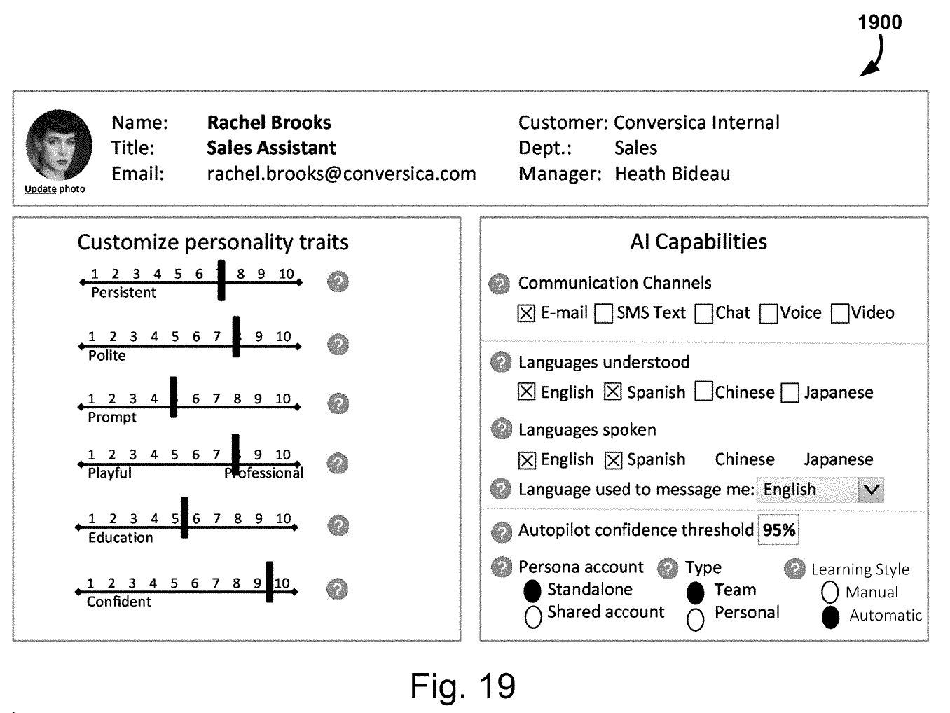

In the following figures, a series of example dashboards and interfaces will be presented. These dashboards and interfaces may be leveraged by users to more intimately and intuitively interact with the AI messaging systems to increase system efficiencies. For example, it may be desirable for a given personality being executed in a conversation to have different personalities based upon customer preference, industry being used in, and similar factors. By augmenting the conversation personalities there is likewise a reduced chance that a target will feel like he is conversing with a machine. FIG. 19 is an example illustration of such a configurable AI personality dashboard within a conversation system, shown generally at 1900. In this example interface, an avatar for the conversation personality and biographical data can be inserted. This may include giving the personality a name, manager/line of business, contact information and role within the organization. A series of slider bars may correspond to specific personality traits, which may be expressed in the conversation outputs. For example, traits like persistence, politeness, promptness, playfulness, perceived education level, and confidence may be selected. The responses generated for a given personality profile, while maintaining the same content, may vary significantly based upon these selections. For example, a polite, professional, educated and confident personality may generate a response that states “Dear Ms. Smith, I appreciate your time, and suggest we schedule a call for tomorrow at 10 am. Please confirm. Cordially, Mrs. Brooks.” In contrast, a less educated, more playful and less confident personality could generate the following: “Hi Mary, great talking. Let's have a call maybe tomorrow? 10ish if that works for you. Thanks!—R.” Note the content of each message is identical: a salutation, followed by an appreciative platitude, and a suggestion for a call at a specific time. However, the selection of word phrases varies significantly based upon personality selections.

In this interface, the user is also capable of selecting other capabilities for the AI personality, including communication channels, languages understood and spoken, and what level of confidence the classification threshold needs to be at before routing to the training desk, as discussed previously. Lastly selection of personal account, type and learning style is selectable by the user. A personal account selection is whether the assistant operates under the user's own name, or if it acts as if they are an independent real person. The type is a selection between the assistant being associated with a single user, or a team. For example a sales assistant may be responsive to the entire sales division, or a single sales representative. Learning style is a selection that determines how the assistant improves over time. This may be either through manual review of non-confident responses, versus automatic learning.

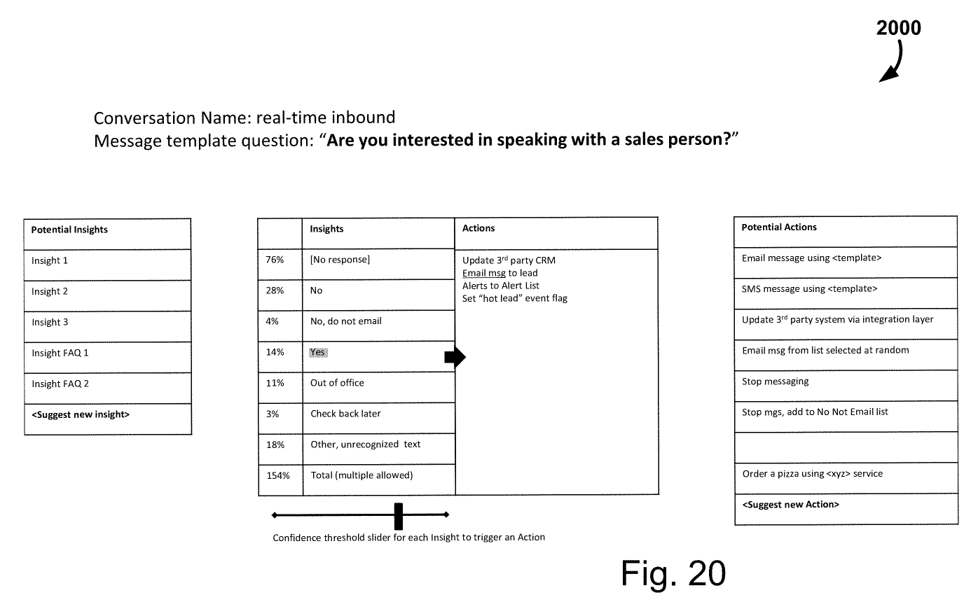

FIG. 20 is an example illustration of a conversation editor dashboard, shown generally at 2000, in accordance with some embodiment. In this example dashboard, for the given node in a decision tree, the prototypical question being asked at this node is listed. Here, in this example illustration, the question is phrased as “are you interested in speaking with a sales person?” A listing of potential intents is listed on one side, along with potential actions on the other. In between them is a listing of intent statements from a lead along with the percentage of the time this type of message is received. The user is capable of selecting any of these response intents, and assigns a subsequent action to the response. A slider bar may also be presented in order to select what confidence threshold in the classification of the intent is needed to automatically take the subsequent action. In this manner a user can very intuitively and easily dictate the progression of the conversation based upon intents that are classified from a response, and tying these to potential actions.

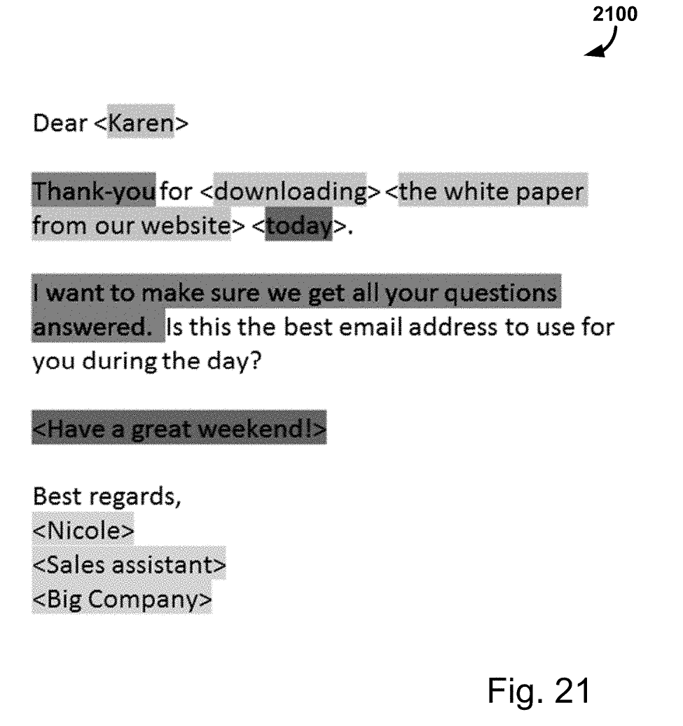

FIG. 21 is an example illustration of a channel specific message template, shown generally at 2100, in accordance with some embodiment. This sort of messaging template may be utilized by a user to edit component content of a message. In this example template editor interface, the types of variable components are each color coded for the user's convenience. Due to coloring limitations imposed by the patent office, each of the variable types in this example message template are illustrated as shaded differing hues of grey as opposed to color coded. The lightest colored variables are customer data, which is seen populating the signature block. Subject or target data is the next lightest variable. This includes the target name “Karen” and actions this target took “downloading the white paper”. Phrase packages, such as salutations and standard boiler plate style statements are coded as the second to most darkly shaded variables. Time variables, such as “today” and “have a great weekend” are shaded the darkest color.

Any of the listed variables may be selected and altered as the user sees fit. This may include basic substitutions of phrase values, custom text insertions, or variable removal or insertions. For example, a template for an SMS message would not include a signature block, unlike an email template might. Likewise, variables that are highlighted, as described previously, may be modified by editing the values, or through direct insertion of different reference data from other systems.

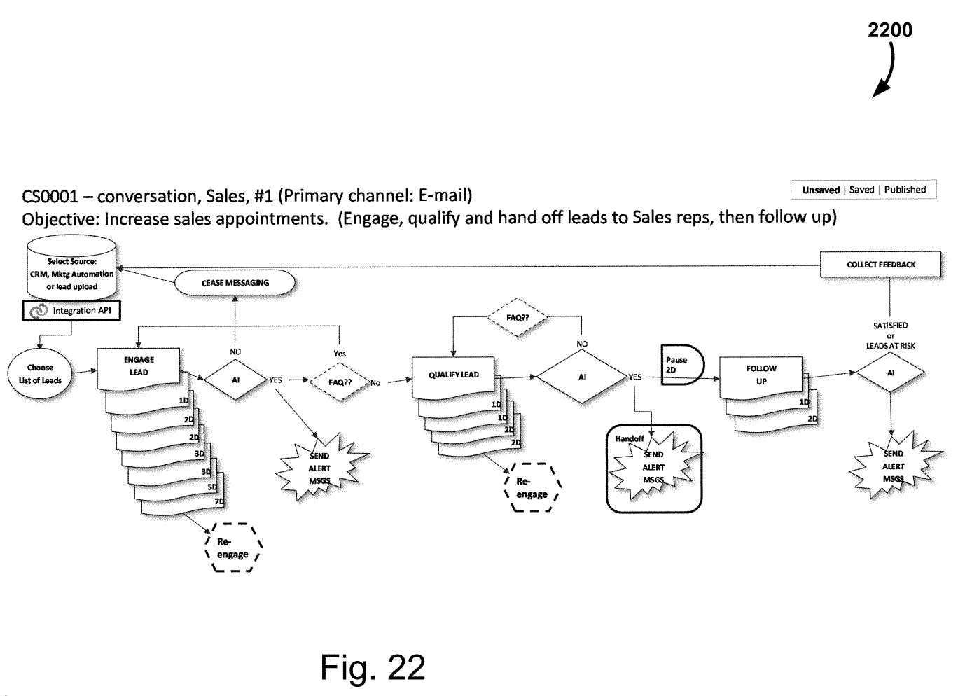

Moving on, FIG. 22 is an example illustration of a graphical conversation overview within a conversation editor tool, shown generally at 2200, in accordance with some embodiment. In this example illustration a rather basic conversation flow is illustrated. In this example conversation overview, the name of the conversation, and conversation objective, are listed. The user has the option to save or publish the conversation. Any conversation component may be selected and edited. For example, at each node a series of message templates are shown. If a user selects any given message in the series, a message template editor screen will be displayed, similar to that shown earlier in relation to FIG. 21. Likewise, if a decision block is selected by the user, a node editor, such as seen in relation to FIG. 20, may be presented to the user. Additional elements may be added to the conversation overview, or removed as desired.

Additionally, and changes to a message template or decision node may automatically update the overview accordingly. For example, at the first message series the lead is engaged. Illustrated in this example are three potential actions that may be taken, the ceasing of contact when a lead declines being engaged, the progression of contact if the lead positively responds to the engagement, and the re-engagement when no response from the user is received. If a user were to select the decision node, the user may see that some segment of the responses is a request to ‘check back later’. The user could choose in this dashboard to assign a delay action and then re-engagement with a more aggressive series of messages aimed at setting up a sales contact meeting. If such an action is set up, when returning to the overview interface of FIG. 22, these changes to the conversation flow will be automatically updated and shown in the flow diagram.

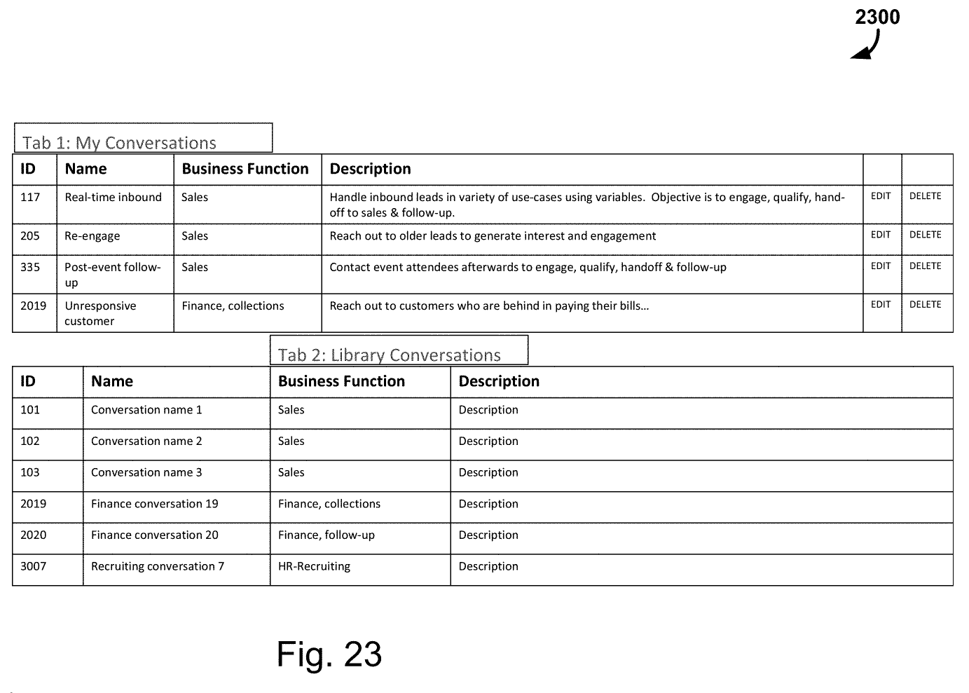

Lastly, FIG. 23 is an example illustration is a conversation editor overview interface, shown generally at 2300, in accordance with some embodiment. This dashboard provides a list view of the various conversations the user has access to, listed by conversation ID, name, purpose, and description. The user has the ability to edit or delete any of these conversations. If a conversation is selected for editing, the user may be routed to the conversation overview dashboard, similar to that seen in relation to FIG. 22. The user may additionally build a new conversation which is then added to the listing of the user's conversations. A new conversation may be built from scratch, but more often is selected from the library of conversations already existing and modified according to the specific goals and needs of the user.

### III. System Embodiments

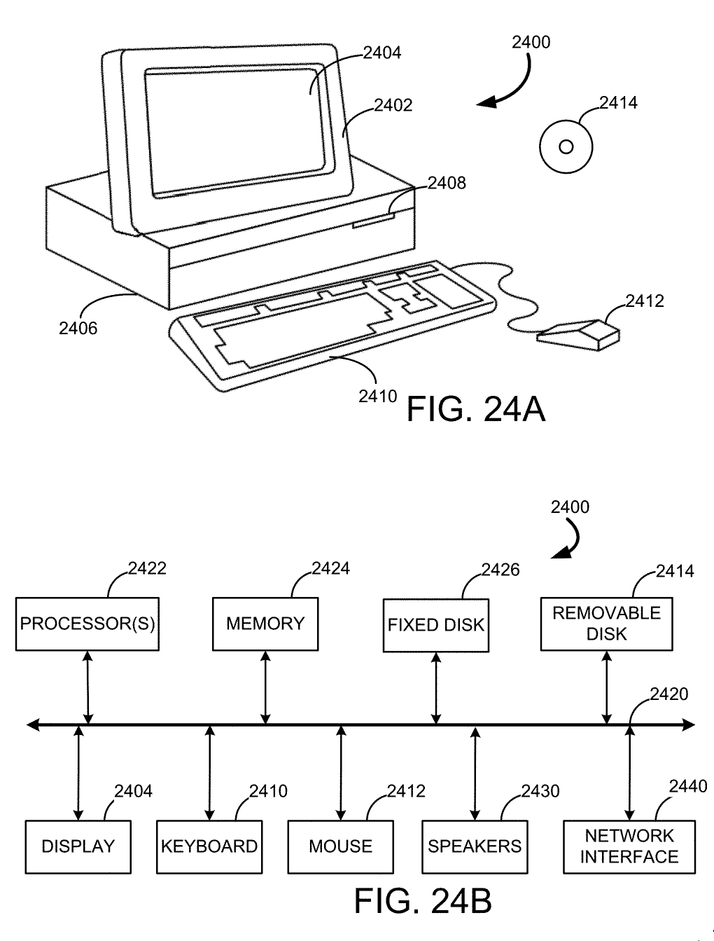

Now that the systems and methods for the conversation generation, message classification, response to messages, and human interaction with the messaging systems though training desk systems, conversation editors, AI assistants, and gamification techniques have been described, attention shall now be focused upon systems capable of executing the above functions. To facilitate this discussion, FIGS. 24A and 24B illustrate a Computer System 2400, which is suitable for implementing embodiments of the present invention. FIG. 24A shows one possible physical form of the Computer System 2400. Of course, the Computer System 2400 may have many physical forms ranging from a printed circuit board, an integrated circuit, and a small handheld device up to a huge super computer. Computer system 2400 may include a Monitor 2402, a Display 2404, a Housing 2406, a Disk Drive 2408, a Keyboard 2410, and a Mouse 2412. Disk 2414 is a computer-readable medium used to transfer data to and from Computer System 2400.

FIG. 24B is an example of a block diagram for Computer System 2400. Attached to System Bus 2420 are a wide variety of subsystems. Processor(s) 2422 (also referred to as central processing units, or CPUs) are coupled to storage devices, including Memory 2424. Memory 2424 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A Fixed Disk 2426 may also be coupled bi-directionally to the Processor 2422; it provides additional data storage capacity and may also include any of the computer-readable media described below. Fixed Disk 2426 may be used to store programs, data, and the like and is typically a secondary storage medium (such as a hard disk) that is slower than primary storage. It will be appreciated that the information retained within Fixed Disk 2426 may, in appropriate cases, be incorporated in standard fashion as virtual memory in Memory 2424. Removable Disk 2414 may take the form of any of the computer-readable media described below.

Processor 2422 is also coupled to a variety of input/output devices, such as Display 2404, Keyboard 2410, Mouse 2412 and Speakers 2430. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, motion sensors, brain wave readers, or other computers. Processor 2422 optionally may be coupled to another computer or telecommunications network using Network Interface 2440. With such a Network Interface 2440, it is contemplated that the Processor 2422 might receive information from the network, or might output information to the network in the course of performing the above-described model learning and updating processes. Furthermore, method embodiments of the present invention may execute solely upon Processor 2422 or may execute over a network such as the Internet in conjunction with a remote CPU that shares a portion of the processing.

Software is typically stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory in this disclosure. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

In operation, the computer system 2400 can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is, here and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

The algorithms and displays presented herein are not inherently related to any particular computer or other apparatus. Various general-purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may, thus, be implemented using a variety of programming languages.

In alternative embodiments, the machine operates as a standalone device or may be connected (e.g., networked) to other machines. In a networked deployment, the machine may operate in the capacity of a server or a client machine in a client-server network environment or as a peer machine in a peer-to-peer (or distributed) network environment.

The machine may be a server computer, a client computer, a virtual machine, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure may be implemented as part of an operating system or a specific application, component, program, object, module or sequence of instructions referred to as “computer programs.” The computer programs typically comprise one or more instructions set at various times in various memory and storage devices in a computer, and when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A computer implemented method for an Artificial Intelligence (AI) assistant for a representative of a messaging system comprising:
receiving an message from a client, wherein the message includes an instruction;
identifying at least one keyword within the message identifying the instruction;
cross referencing the instruction keyword to a list of possible actions to determine which action is appropriate; and
executing the determined action.

2. The method of claim 1, wherein the list of possible actions include messaging a target of an automated conversation.

3. The method of claim 1, wherein the list of possible actions include creating an event on a calendar program for the representative.

4. The method of claim 3 wherein the list of possible actions includes inviting a target of an automated conversation to the event.

5. The method of claim 1, further comprising classifying the message.

6. The method of claim 5, further comprising cross referencing the classification of the message against command sets to determine which action is appropriate.
